(19) United States
(12) Patent Application Publication
(10) Pub. No.: US 2026/0056870 A1
(43) Pub. Date: Feb. 26, 2026

(54) GENERATION OF TEST SCRIPTS AND REPORTS FOR VERIFYING AND VALIDATING APPLICATIONS USING GENERATIVE MODELS

(71) Applicant: Click Therapeutics, Inc., New York, NY (US)

(72) Inventors: Heather Morris, Chappaqua, NY (US); Amanda Huey, Brooklyn, NY (US)

(73) Assignee: Click Therapeutics, Inc., New York, NY (US)

(21) Appl. No.: 18/811,218

(22) Filed: Aug. 21, 2024

(51) Int. Cl. G06F 11/36; G06F 8/71

(52) U.S. Cl. CPC G06F 11/3684; G06F 8/71; G06F 11/3688

(57) ABSTRACT

Aspects of the present disclosure are directed to systems, methods, and computer readable media for automated generation of test scripts and documentation for verifying and validating digital therapeutics applications. A service may receive a test configuration identifying a plurality of test cases to check an application executable on a user device for addressing an indication of a user. The service may provide a model input generated using the test configuration to a generative model. The generative model may be trained a set of corpora identifying test cases and test packages. The service may generate, based on providing the model input to the generative model, a test package defining execution of the plurality of test cases to check the application. The service may store an association between the application and the test package on a database.

### BACKGROUND

A digital therapeutic application is an application that delivers evidence-based therapeutic interventions directly to an end-user with an aim of preventing, alleviating, or treating a wide-range of diseases, medical conditions, or symptoms of the end-user. Certain digital therapeutic applications are subject to clinical trials and an approval process to demonstrate that these applications are effective and safe for use. This involves rigorous testing of the application, the results of which are used as submission materials to regulatory agencies (e.g., U.S. Food and Drug Administration (FDA)) or third parties to obtain approval or clearance. As part of this process, it is important that the digital therapeutic application that is designed precisely matches the application that is tested, approved, and ultimately deployed. Any discrepancies between the as designed application and as deployed application could compromise therapeutic efficacy and safety. Proper verification and validation (V&V) procedures are critical to achieve this match between the as-designed and as-deployed application.

The V&V processes are critical stages of the software development process, ensuring that the software is built correctly and satisfies the intended purpose prior to rolling out to end users. Verification refers to the process of evaluating whether the software complies with specified requirements, ensuring that the software is developed according to the design specifications. Validation refers to the process of evaluating the software during or at the end of the development process to determine whether the software satisfies the specified requirements and user's expectation with respect to the software. The V&V process entails providing evidence (e.g., in the form of documentation) that the software is implemented in a manner that effectively and properly fulfills the requirements and intended use. The creation of test scripts and documentation for V&V for applications in general is a labor-intensive process that involves several teams of developers. As a result, quality assurance teams can end up spending hundreds of hours and several weeks preparing detailed scripts and documentation for each V&V period. The extensive time committed to V&V documentation and script writing extends the development cycles of software for medical device applications. The time consumed in preparing such documentation can be exacerbated, when there are additional scrutiny and requirements imposed by third-party entities, in particular with those related to efficacy and safety. Once the V&V processes are successful, the software may be deployed to end users.

The requirements and testing procedures under V&V for certain software such as digital therapeutic applications are heightened, necessitating very intensive V&V processes to ensure the application satisfies certain requirements. For example, the development and deployment of software for medical device contexts (e.g., software as a medical device (SaMD) or software in medical device (SiMD)) is a highly regulated process. This is because of the requirements imposed by the software developers themselves and by third-party entities, including regulatory agencies, hospitals, device manufacturers, customers, and patients, among others. For instance, the FDA specifies particular requirements for V&V testing such as with functionality and the reporting of testing results. The reports should demonstrate traceability to user needs, fulfillment of product and design specifications, and test results when submitted as part of an application for medical device clearance.

One of the technical challenges with prior approaches to testing and execution of the software is in the discrepancies between software as designed (e.g., testing plans) and software as implemented (i.e., testing script) in the V&V process. These discrepancies can include, for example, mismatches in functionalities, user interface design, performance, compliance, and security, among others. These discrepancies are typically only identified towards the end of the V&V process, when the test plans, based on the software as designed, are executed. Late-stage discoveries of mismatches between the planned and actual functionalities of the software can lead to significant last-minute adjustments that can delay the entire project. Not to mention, execution of the software in accordance with the incongruent test plans leads to wasted consumption in computing resources and network bandwidth from communications.

Furthermore, in the context of digital therapeutics applications, testing and redrafting the testing scripts leads to delays in the V&V process itself. These delays in testing lead to postponement in the generation of the V&V related documentation that comply with the software clearance requirements set out by the developer and third-party entities (e.g., FDA clearance and approval). Even when complete, the V&V testing and documentation often suffer from mismatches and discrepancies between planned and implemented functionalities, thereby further delaying the approval and clearance process. These compounded delays in V&V testing and documentation postpone the roll out of the digital therapeutics' application, medical device, or software to a user enrolled in digital therapeutics. These postponements in turn stall the proper clinical testing to test whether the application is effective and deprive users from receiving digital interventions that could alleviate their disease, condition, or symptoms. As a result, the delay could lead to lower adherence to the treatment and lower efficacy of the therapeutic intervention on the user.

### SUMMARY

Presented herein are systems and methods of using a generative machine learning model to create test configurations including test documentation and scripts to define testing of an application for verification and validation (V&V). There are a number of advantages achieved by leveraging generative machine learning models to create test packages. For one, the digital therapeutic application can be rolled out to users faster, thereby providing users access to therapeutic interventions that can address their medical diseases, conditions, or symptoms, thereby improving health outcomes and quality of life. The use of the generative machine learning model allows for not only faster generation of V&V testing scripts and documentation, but also more rapid and reliable testing of the digital therapeutic application for therapeutic efficacy and safety. A digital therapeutic application that has undergone rigorous V&V processes helps ensure that the end product not only satisfies software specifications but also functions properly as intended when deployed. The V&V processes facilitated by the generative machine learning model provides for identification and mitigation of errors and risks in the digital therapeutic application, thereby reducing application risks to the end-users. This permits end-users to receive more reliable and effective digital therapeutic applications, granting such users access to higher quality care, better diagnostic determinations, and overall improved health.

For another, for applications such as digital therapeutic applications that are subject to third-party entity requirements, the generative machine learning model provides for faster generation of V&V testing scripts and documentation that incorporate the requirements specified by third-party entities in addition to those defined by the primary developers. The improvement in the speed and quality of V&V testing and related documentation allays concerns in development and the testing documents, especially from the perspective of these third-party entities (e.g., FDA, clinical entities, customers, and patients). These entities are more likely to expedite their approval processes when they are presented with clear, comprehensive, and conclusive V&V data and documentation. By reducing the time to release the application, developers can offer their digital therapeutic applications to users sooner. This is particularly critical in the medical field, where timely access to new treatments and technologies can significantly impact patient outcomes and quality of life.

In addition, the generative machine learning model provides significant time savings for completion of the V&V process of the application from start to finish, on the order of months with manual process to days. The time savings allow for quicker launches of the application from development to roll out. The generative model has the additional benefit of saving resources for targeted and more refined quality engineering and quality assurance (QE & QA) on the application. This is particularly valuable when considering supporting many V&V efforts within a small time period. Reviewing AI-generated plans and scripts for accuracy is a much lower burden on time than generation of these deliverables from manual source. There is also a reduced risk of human error (e.g., typographical errors, missed steps, or missed traceability) affecting the plans and the scripts.

Aspects of the present disclosure are directed to systems, methods, and computer readable media for automated generation of test scripts for verifying and validating digital therapeutics applications. The one or more processors may receive a test configuration identifying a plurality of test cases to check an application executable on a user device for addressing an indication of a user. The one or more processors may provide a model input generated using the test configuration to a generative model. The generative model can be established using a plurality of corpuses. Each of the plurality of corpuses identifying (i) a respective plurality of test cases to check a respective application and (ii) a respective test package defining execution of the respective plurality of test cases. The one or more processors may generate, based on providing the model input to the generative model, a test package defining execution of the plurality of test cases to check the application. The one or more processors may store an association between the application and the test package on a database.

In some embodiments, the test configuration can include (i) a scenario file defining a condition to test the application and an expected result from the application for at least one of the plurality of test cases, and (ii) a traceability table defining an association between a risk control measure and a specification for the application. In some embodiments, test configuration can include at least one of: (iii) a specification document identifying a function to be executable by the application, or (iv) a code history identifying a modification to a code for the application. In some embodiments, at least one of the plurality of corpuses identifies a respective test document identifying a respective scheme defining execution of the respective plurality of test cases of corresponding computer-executable instructions of a respective test script. In some embodiments, the one or more processors may generate a test document identifying a scheme to define execution of the plurality of test cases of computer-executable instructions of a test script.

In some embodiments, the one or more processors may generate a test script having computer-executable instructions identifying, for at least one test case of the plurality of test cases: (i) a condition for the application, (ii) a result expected from the application for the respective condition, (iii) a criterion against which to determine whether the at least one test case is satisfied, and (iv) a traceability mapping between the at least one test case and a risk control measure. In some embodiments, the one or more processors may execute computer-executable instructions of a test script for at least one of the plurality of test cases. In some embodiments, the one or more processors may store, on the database, an association between the test script and an outcome of executing the at least one test case.

In some embodiments, the one or more processors may generate a report identifying the outcome of the at least one test case based on execution of the at least one test case. In some embodiments, the one or more processors may receive, via a user interface, a selection of one of approval or rejection of the test script. In some embodiments, the one or more processors execute the computer-executable instructions in response to the selection identifying approval.

In some embodiments, the one or more processors may receive feedback data identifying a modification to the test script. In some embodiments the one or more processors may update at least one of a plurality of weights of the generative model using the feedback data. In some embodiments, the one or more processors may receive, via a user interface, user input defining the plurality of test cases of the test configuration. In some embodiments, the one or more processors may provide, via the user interface, data associated with the test package.

In some embodiments, the one or more processors may provide a user interface including at least one of: (i) a user interface to accept the test configuration; (ii) a user interface element to generate one or more test packages, (iii) a user interface element to select from the one or more test packages for execution, (iv) a user interface to generate outputs using the execution of the one or more test packages, or (v) a user interface to provide a report generated based on the execution of the one or more test packages to a remote device. In some embodiments, at least one of the plurality of corpuses includes a mapping between (i) a feature in at least one of (a) a respective scenario file, (b) a respective traceability table, (c) a specification document, or (d) a code history, with (ii) a feature in a respective test script. In some embodiments, at least one of the plurality of test cases can identify a risk control measure for the application to be checked. In some embodiments, the user may be administered with an effective amount of a medication to address the indication, concurrently with provision of the application.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 depicts a block diagram of a system for automated generation of test scripts for verifying and validating digital therapeutics applications in accordance with an illustrative embodiment;

FIG. 2 depicts a block diagram for a process to train a generative model in the system for automated generation of test scripts in accordance with an illustrative embodiment;

FIG. 3 depicts a block diagram for a process to apply test configurations for an application to a generative model to generate test scripts in the system for automated generation of test scripts in accordance with an illustrative embodiment;

FIG. 4 depicts a block diagram for a process to execute the test script against test cases to generate a report and store an association in a database in the system for automated generation of test scripts in accordance with an illustrative embodiment;

FIG. 5 depicts a block diagram for a process to update the generative models in the system for automated generation of test scripts in accordance with an illustrative embodiment;

FIG. 6A-D depicts examples of a dashboard user interface to accept a test configuration, generate test packages, select test packages, and generate outcomes, in accordance with an illustrative embodiment;

FIG. 7 depicts a block diagram for a process to tag training data for the generative model, in accordance with an illustrative embodiment;

FIG. 8 depicts a flow diagram of a method of automated generation of test scripts for verifying and validating digital therapeutics applications in accordance with an illustrative embodiment; and

FIG. 9 is a block diagram of a server system and a client computer system in accordance with an illustrative embodiment.

### DETAILED DESCRIPTION

For purposes of reading the description of the various embodiments below, the following enumeration of the sections of the specification and their respective contents may be helpful:

Section A describes systems and methods for automated generation of test scripts and documents for verifying and validating applications; and

Section B describes a network and computing environment which may be useful for practicing embodiments described herein.

### A. Systems and Methods for Automated Generation of Test Scripts and Documents for Verifying and Validating Applications

Presented herein are systems and methods for automated generation of test scripts and reports for verifying and validating applications. An application testing service may train and establish a generative model for creating test packages using training data. The generative model may be implemented using a language model (e.g., a large language model (LLM) or a small language model (SLM)) that is pretrained on a set of general corpora. To further fine-tune, the application testing service may use training data specific to validation and verification (V&V) of applications. The training data may include, for example, test scripts exported from manual test script tracking tools; a test plan documentation; code change history (e.g., commit log histories); test cases (e.g., Gherkin files containing BDD tests); software requirements documentation; traceability matrix documentation; and software design specification documentation, among others. The training data may be labeled in such a way to associate a test case scenario with test scripts for checking the same functionality, the relevant software requirements and specification documentation, traceability matrices, and code change histories, among others. The application test service may fine-tune the generative model using the training data.

With the establishment of the generative model, the application testing service may receive a testing configuration to test an application. The testing configuration may include relevant data for checking (e.g., V&V process) of the application, such as a traceability table, a software requirements and specifications document, a code change history, and a test cases (e.g., defined using Gherkin). Using the testing configuration, the application testing service may create a prompt to be used as input to the generative model. The application testing service may apply the prompt to the generative model to output a test package defining the execution of the test cases for checking the application. The test package may include a test strategy document and a test script.

The test plan may be populated by the generative model with a test strategy, a test device, and a test summary. The test strategy or scheme document may include a specification in compliance with the method of strategy documentation (e.g., sampling method of what is tested and how many times). This may include a calendar of days to specify when testing activities are planned to take place. The test devices may identify devices in compliance with methods based on design specifications and data on user devices in distribution. The test summary may include an explanation of applicable updates for traceability table.

The test script may be created by the generative model with a series of testing steps (e.g., in an executable file). The testing steps may cover work as determined by code change history. Each of the testing steps may define an action to be performed on the application (e.g., as specified in a test case in the Gherkin file) and an expected result for the test case. In addition, the testing step may specify providing or non-providing scenarios, when the step is to check whether a software requirement is satisfied (e.g., in accordance with software requirements documentation) or whether an anomaly has been resolved (e.g., as specified in code change history). The test case may also identify traceability to the relevant user need, product requirement, and risk controls, among others.

With the output, the application testing service may present the output test package for the user for review and approval. The user may provide feedback data to modify or adjust the test script. Once approved by the user, the application testing service may include the modifications into test package if any, and may carry out the test scripts. Based on the results of the testing, the application testing service may generate a report identifying the outcome of each test case. The report may be presented on the user interface for review by the user. The application testing service may store the test package as well as the test results on a database for future fine-tuning of the generative model.

In this manner, the application testing service may significantly improve the reliability, quality, and overall performance of the resulting application through the V&V process. Since the generative model is particularly trained for V&V and used to create the test package containing the test specification and test script, there may be a reduction in the occurrence of discrepancies between the specification and script. The reduction of discrepancies may ensure that functionalities, user interface design, performance, compliance, and security features of the application are properly tested for V&V. In addition, the use of the generative model to create the test package may drastically reduce the amount of time and effort taken in testing the application.

Since the generative machine learning model is used to create both the test document specifying the software as designed and the test script relevant to the checking the software as implemented, the chances of discrepancies may be greatly reduced or eliminated. This can decrease the likelihood of mismatches between functionalities, user interface design, performance, compliance, and security, among others, as intended versus as implemented. By catching potential problems before they become ingrained in the design, developers can avoid the costly and time-consuming revisions that occur in later stages of software development. The reduction or elimination of discrepancies results in a finalized application with enhanced reliability, quality, and overall performance.

Furthermore, the generative machine learning model may be trained with test specifications particular to a given type of application. The generative machine learning model may be implemented using a language model (e.g., an LLM) initially trained using a large corpus of test specifications for various types of applications. The corpus may include test cases, traceability, software requirement documents, code change history, and other test documentation, among others, for training the generative machine learning model. The generative machine learning model is able to further be fine-tuned on particular types of applications, using test specifications for other applications of the given type. With the generative machine learning model trained particularly for software for medical devices, the output test documentation and scripts can fulfill the requirements particular to such applications.

The generative machine learning model also can facilitate the use of behavior driven design (BDD) in connection with the V&V process for the application. BDD allows for composition of test cases in a natural language (e.g., in a Gherkin file), with each test case specifying a set of conditions and end results to verify. The generative machine learning model may be provided with a test package including test cases written in natural language as input when producing a test configuration with test documentations and scripts as output. By using natural language to specify conditions and expectations, various entities (e.g., regulatory agencies, clinical entities, customers, and patients) involved in the development process can more easily understand, discuss, and contribute to the development process. The generative machine learning model allows for early identification of issues and misunderstandings regarding the functionality, and quick incorporation of any feedback and modifications to the testing parameters. The generative machine learning model can provide for faster, more reliable completion of the V&V process and deployment of the application.

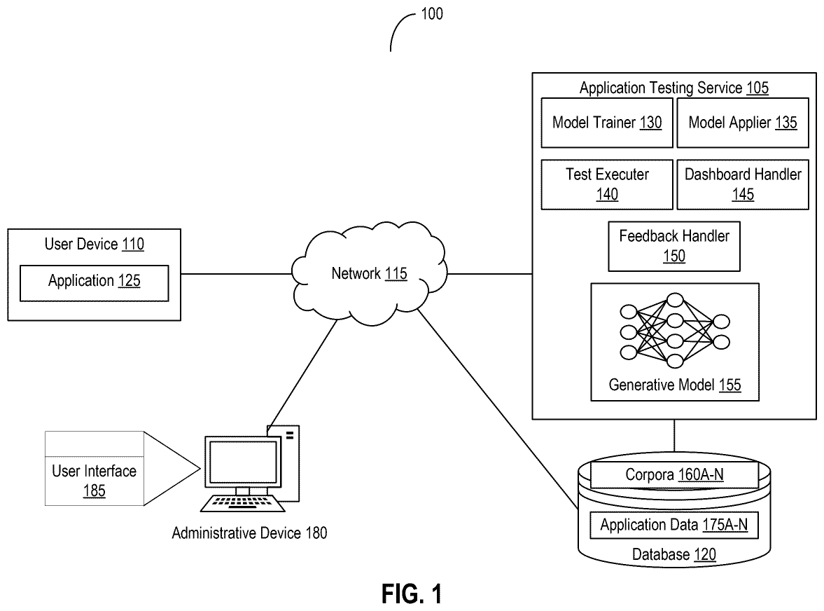

Referring now to FIG. 1, depicted is a block diagram of a system 100 for automated generation of test scripts for verifying and validating digital therapeutics applications. In an overview, the system 100 may include at least one application testing service 105, a set of user devices 110, at least one administrative device 180, communicatively coupled with one another via at least one network 115. At least one of the user devices 110 may include at least one application 125. The application testing service 105 may include at least one model trainer 130, at least one model applier 135, at least one test executer 140, at least one dashboard handler 145, at least one feedback handler 150, and at least one generative model 155 herein), among others. The application testing service 105 may include or have access to at least one database 120. The database 120 may store, maintain, or otherwise include one or more corpora 160A-N (hereinafter generally referred to as corpus 160) and application data 165A-N (hereinafter generally referred to as application data 165. The functionalities of the application 125 on the user device 110 may be performed in part on the application testing service 105, and vice-versa.

In further detail, the application testing service 105 may be any computing device comprising one or more processors coupled with memory and software and capable of performing the various processes and tasks described herein. The application testing service 105 may be in communication with the one or more user devices 110 and the database 120 via the network 115. The application testing service 105 may be situated, located, or otherwise associated with at least one computer system. The computer system may correspond to a data center, a branch office, or a site at which one or more computers corresponding to the application testing service 105 are situated.

Within the application testing service 105, the model trainer 130 may train, improve, or update the generative model 155 related to a session initiated by a user of the application 125. The model applier 135 may validate, verify, or otherwise establish a test configuration, test cases, and application data (i.e., inputs) and feed the inputs to the generative model 155. The test executer 140 may execute, apply, or otherwise run one or more test scripts generated by the generative model 155. The dashboard handler 145 may generate, create, or otherwise provide a report corresponding to the outcome of the test script. The feedback handler 150 may generate feedback data using feedback from the user device 110 to update the generative model 155.

The generative model 155 may receive inputs in the form of a set of strings (e.g., from a text input) to output content in one or more modalities (e.g., in the form of text strings, audio content, images, video, or multimedia content). The generative model 155 may be a machine learning model in accordance with a transformer model (e.g., generative pre-trained model or bidirectional encoder representations from transformers). The generative model 155 can be a large language model (LLM), a text-to-image model, a text-to-audio model, or a text-to-video model, among others. In some embodiments, the generative model 155 can be a part of the application testing service 105 (e.g., as depicted). In some embodiments, the generative model 155 can be part of a server separate from and in communication with the application testing service 105 via the network 115.

The generative model 155 can include a set of weights arranged across a set of layers in accordance with the transformer architecture. Under the architecture, the generative model 155 can include at least one tokenization layer (sometimes referred to herein as a tokenizer), at least one input embedding layer, at least one position encoder, at least one encoder stack, at least one decoder stack, and at least one output layer, among others, interconnected with one another (e.g., via forward, backward, or skip connections). In some embodiments, the transformer layer can lack the encoder stack (e.g., for a decoder-only architecture) or the decoder stack (e.g., for an encoder-only model architecture). The tokenization layer can convert raw input in the form of a set of strings into a corresponding set of word vectors (also referred to herein as tokens or vectors) in an n-dimensional feature space. The input embedding layer can generate a set of embeddings using the set of word vectors. Each embedding can be a lower dimensional representation of a corresponding word vector and can capture the semantic and syntactic information of the string associated with the word vector. The position encoder can generate positional encodings for each input embedding as a function of a position of the corresponding word vector or by extension the string within the input set of strings.

Continuing on, in the generative model 155, an encoder stack can include a set of encoders. Each encoder can include at least one attention layer and at least one feed-forward layer, among others. The attention layer (e.g., a multi-head self-attention layer) can calculate an attention score for each input embedding to indicate a degree of attention the embedding is to place focus on and generate a weighted sum of the set of input embeddings. The feed-forward layer can apply a linear transformation with a non-linear activation (e.g., a rectified linear unit (ReLU)) to the output of the attention layer. The output can be fed into another encoder in the encoder stack in the transformer layer. When the encoder is the terminal encoder in the encoder stack, the output can be fed to the decoder stack.

The decoder stack can include at least one attention layer, at least one encoder-decoder attention layer, and at least one feed-forward layer, among others. In the decoder stack, the attention layer (e.g., a multi-head self-attention layer) can calculate an attention score for each output embedding (e.g., embeddings generated from a target or expected output). The encoder-decoder attention layer can combine inputs from the attention layer in the decoder stack and the output from one of the encoders in the encoder stack and can calculate an attention score from the combined input. The feed-forward layer can apply a linear transformation with a non-linear activation (e.g., a rectified linear unit (ReLU)) to the output of the encoder-decoder attention layer. The output of the decoder can be fed to another decoder in the decoder stack. When the decoder is the terminal decoder in the decoder stack, the output can be fed to the output layer.

The output layer of the generative model 155 can include at least one linear layer and at least one activation layer, among others. The linear layer can be a fully connected layer to perform a linear transformation on the output from the decoder stack to calculate token scores. The activation layer can apply an activation function (e.g., a softmax, sigmoid, or rectified linear unit) to the output of the linear function to convert the token scores into probabilities (or distributions). The probability may represent a likelihood of occurrence for an output token, given an input token. The output layer can use the probabilities to select an output token (e.g., at least a portion of output text, image, audio, video, or multimedia content with the highest probability). Repeating this over the set of input tokens, the resultant set of output tokens can be used to form the output of the overall generative model 155. While described primarily herein in terms of transformer models, the application testing service 105 can use other machine learning models to generate and output content.

The user device 110 (sometimes herein referred to as an end user computing device) may be any computing device comprising one or more processors coupled with memory and software and capable of performing the various processes and tasks described herein. The user device 110 may be in communication with the application testing service 105, the administrative device 180, and the database 120 via the network 115. The user device 110 may be a smartphone, other mobile phone, tablet computer, wearable computing device (e.g., smart watch, eyeglasses), or laptop computer. The user device 110 may be used to access the application 125. In some embodiments, the application 125 may be downloaded and installed on the user device 110 (e.g., via a digital distribution platform). In some embodiments, the application 125 may be a web application with resources accessible via the network 115.

In some embodiments, the user device 110 may correspond to a virtual machine running on a hardware. For example, the user device 110 may be a virtual machine with an operation system and the application 125 executing on a physical computing device such as a server and may be managed by a hypervisor. The virtual machine may be part of the isolated, controlled sandbox environment corresponding to a test environment for testing the application 125. In some embodiments, the user device 110 may be a physical device. For instance, the user device 110 may be a smartphone, other mobile phone, tablet computer, wearable computing device (e.g., smart watch, eyeglasses), or laptop computer.

The application 125 executing on the user device 110 may be a digital therapeutics application and may provide a session (sometimes referred to herein as a therapy session) to address at least one condition (or indication) of the user. The condition of the user may include, for example, a chronic pain (e.g., associated with or include arthritis, migraine, fibromyalgia, back pain, Lyme disease, endometriosis, repetitive stress injuries, irritable bowel syndrome, inflammatory bowel disease, and cancer pain), a skin pathology (e.g., atopic dermatitis, psoriasis, dermatillomania, and eczema), a cognitive impairment (e.g., mild cognitive impairment (MCI), Alzheimer's, multiple sclerosis, and schizophrenia), a mental health condition (e.g., an affective disorder, bipolar disorder, obsessive-compulsive disorder, borderline personality disorder, and attention deficit/hyperactivity disorder), a substance use disorder (e.g., opioid use disorder, alcohol use disorder, tobacco use disorder, or hallucinogen disorder), and other ailments (e.g., narcolepsy and oncology), among others.

The end user may be taking or being administered with a medication to address the indication (or condition), in at least partial concurrence with the use of the application 125 (e.g., for any number of sessions). For instance, if the medication is for pain, the end user may be taking acetaminophen, a nonsteroidal anti-inflammatory composition, an antidepressant, an anticonvulsant, or other composition, among others. For skin pathologies, the end user may be taking a steroid, antihistamine, or topic antiseptic, among others. For cognitive impairments, the end user may be taking cholinesterase inhibitors or memantine, among others. For a mental condition, the end user may be taking antidepressants, mood stabilizers, antipsychotics, anxiolytics, or stimulants, among others. For substance abuse disorders, the end user may be taking a naltrexone, disulfiram, acamprosate, or nicotine replacement therapy, among others. The application 125 may increase efficacy of the medication that the user is taking to address the condition.

The application 125 may be tested for verification and validation (V&V) in a test environment. The test environment may correspond to or include an environment in which to test, verify, validate, or otherwise evaluate the application 125 on the user device 110. In some embodiments, the test environment may be created, instantiated, or otherwise generated by the test management service 105 for facilitating evaluation of the application 125 on the user device 110. For example, the test environment may be an isolated, controlled, sandbox environment or a secure container to facilitate testing of the application 125 on the user device 110. In some embodiments, the test environment may include the application testing service 105 together with the user device 110 to facilitate evaluation of the application 125 on the user device 110 and the application testing service 105.

The database 120 may store and maintain various resources and data associated with the application testing service 105 and the application 125. The database 120 may include a database management system (DBMS) to arrange and organize the data maintained thereon, as the corpus 160 and application data 165, among others. The database 120 may be in communication with the application testing service 105 and the one or more user devices 110 via the network 115. While running various operations, the application testing service 105 and the application 125 may access the database 120 to retrieve identified data therefrom. The application testing service 105 and the application 125 may also write data onto the database 120 from running such operations.

Each corpus 160 can identify or include a set of texts (or data in any type). In some embodiments, at least one of the corpora 160 can be generalized dataset. For instance, the generalized text for the corpus 160 can be obtained from a large and unstructured set of text without any focus to a particular knowledge domain. In some embodiments, at least one of the corpora 160 can include knowledge domain-specific dataset. The knowledge domain-specific dataset may include a set of strings identifying a set of test cases (e.g., code to check or verify the application) to be executed and another set of strings defining a set of test packages (e.g., code to execute the test cases for the application) to define the execution of the test cases. For example, the corpus 160 can include a set of texts obtained from files (e.g., Gherkin files) describing a particular test case for an application associated with users and a set of test packages to execute the files to verify the functionality of the application.

On the database 120, the application data 165 can store and maintain information related to the application 125 through user device 110. The information related to the application may include a version, a condition associated with the user of the application, encryption information, a changelog, a frequency of updates, a traceability table document, software requirements documents, software design specification, and code change history, among others. The application data 165 can include risk control measures for different aspects of the application 125.

The administrative device 180 (sometimes herein referred to as an end user computing device) may be any computing device comprising one or more processors coupled with memory and software and capable of performing the various processes and tasks described herein. The administrative device 180 may be in communication with the application testing service 105, the user device 110, and the database 120 via the network 115. The administrative device 180 may be a smartphone, other mobile phone, tablet computer, wearable computing device (e.g., smart watch, eyeglasses), or laptop computer. The administrative device 180 may be used to access the application 125. In some embodiments, the application 125 may be downloaded and installed on the administrative device 180 (e.g., via a digital distribution platform). In some embodiments, the application 125 may be a web application with resources accessible via the network 115.

The administrative device 180 may display, present, or otherwise provide a user interface 185 including the one or more user interface elements. The user interface elements may correspond to visual components of the user interface 185, such as a command button, a text box, a check box, a radio button, a menu item, and a slider, among others. The user interface 185 may be provided by the application testing service 105, and may be used to access functionalities and resources on the application testing service 105. In some embodiments, the user interface 185 may include a user interface to accept the test configuration. In some embodiments, the user interface 185 may include a user interface element to generate one or more test packages. In some embodiments, the user interface 185 may include a user interface element to select from the one or more test packages for execution. In some embodiments, the user interface 185 may include a user interface to generate outputs using the execution of the one or more test packages

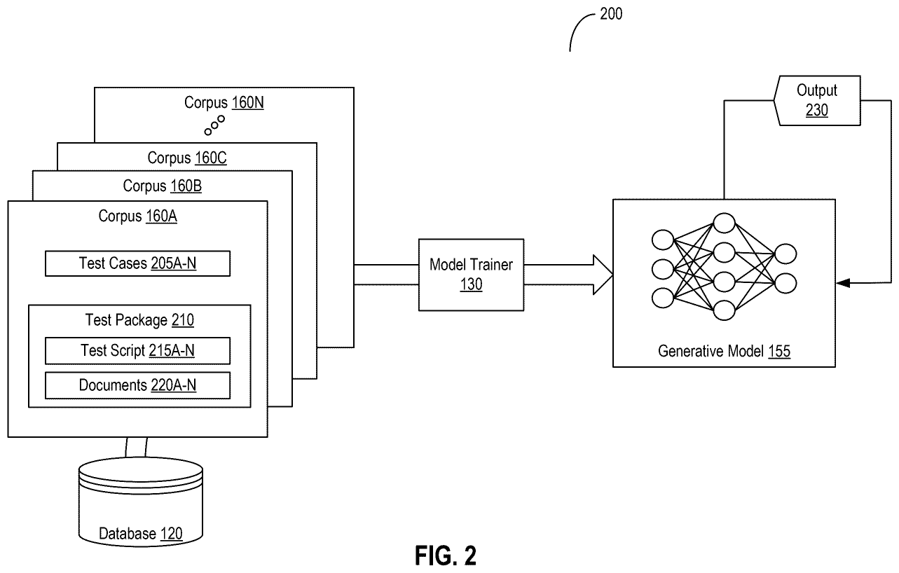

Referring now to FIG. 2, depicted is a block diagram for a process 200 to train a generative transformer model in the system 100 for automated generation of test scripts for verifying and validating digital therapeutics applications. The process 200 may include or correspond to operations performed in the system 100 to train the generative model 155. Under process 200, the model trainer 130 executing on the application testing service 105 can retrieve, receive, or identify a set of corpora 160A-N (hereinafter referred to as corpus 160) for training the generative model 155. Each corpus 160 can identify or include a set of texts. In some embodiments, at least one of the corpora 160 can be generalized dataset. For instance, the generalized text for the corpus 160 can be obtained from a large and unstructured set of text without any focus to a particular knowledge domain.

In some embodiments, at least one of the corpora 160 can include knowledge domain-specific dataset. The knowledge domain-specific dataset may include a set of strings identifying a set of test cases (e.g., code to check or verify the application) to be executed and another set of strings defining a set of test packages (e.g., code to execute the test cases for the application) to define the execution of the test cases. For example, the corpus 160 can include a set of texts obtained from files (e.g., Gherkin files) describing a particular test case for an application associated with users and a set of test packages to execute the files to verify the functionality of the application. The corpus 160 may include data related to the testing of a given sample application. The sample application may be in the same field as the application 125. For example, the sample application associated with the corpus 160 may be for a digital therapeutic application for addressing insomnia, whereas the application 125 may be for a digital therapeutic application for addressing narcotic addiction. The sample application may also be in a different field. For instance, the sample application associated with the corpus 160 may be a word processor, whereas the application 125 to be tested may be an application to process images from a medical imaging device.

Each corpus 160 may include a sample set of test cases 205A-N (generally referred to as test cases 205 herein) and at least one test package 210, among others, to train the generative model 155. The set of test cases 205 may be defined using one or more scenario files including natural language (e.g., Gherkin) or human-readable instructions (e.g., YAML, or Extensible Markup Language (XML)). Each test case 205 may include, define, or otherwise identify: at least one condition to be checked for the application, a result from the application for the condition, or at least one criterion to determine whether the test case 205 is satisfied. The condition may specify prerequisites to be met prior to carrying out the test specified by the test case 205. The result may identify an anticipated outcome of the test of the test case 205 when carried out. The criterion may be used to determine whether the test has succeeded or failed.

In some embodiments, the test case 205 may include at least one traceability mapping between the test case 205 (e.g., the condition of the test case 205) and a risk control measure for the application. The risk control measure may define at least one event for which to monitor on the application and at least one mitigation to be carried out in response to the occurrence of the event. For example, for the risk control measure, the event may be a display of the digital therapeutic content via a user interface element directing the user to perform an activity to aid in amelioration of a symptom associated with an indication. The mitigation may specify that if the content is not successfully shown through the user interface element, the application is to present the content as a push notification on the user device 110. In some embodiments, the test cases 205 may include unit tests (e.g., tests to check individual components of the application), integration tests (e.g., tests to check individual the interaction between the application and the user device 110), functional tests (e.g., tests to check that the application functions as expected for the user), and end-to-end tests (e.g., simulate user interactions with the application), among others.

The test package 210 may define or specify execution of the test cases 205 to verify, validate, or otherwise check (e.g., V&V) the sample application. The test package 210 may include or identify a set of test scripts 215A-N (hereinafter generally referred to as test scripts 215). Each test script 215 may include computer-executable instructions (e.g., JavaScript, Python, Ruby, C, C++, or PHP) to be performed by the application testing service 105 to execute the test cases 205. Each test script 215 may correspond to at least one of the test cases 205. The test script 215 may define or identify at least one condition to be checked for a sample application, a result from the application for the condition, a set of test steps for carrying out the test case 205 associated with the test script 215, or at least one criterion to determine whether the condition of the test case 205 is satisfied. The condition may specify prerequisites to be met prior to carrying out the test specified by the corresponding test case 205. The result may identify an anticipated outcome of the test of the corresponding test case 205 when carried out. The criterion may be used to determine whether the test has succeeded or failed. The test steps may include a set of instructions (e.g., computer-executable instructions) for carrying out the corresponding test case 205. In some embodiments, the test script 215 may include instructions for checking at least one traceability mapping (or table) between the test case 205 and a risk control measure for a given application.

The test package 210 may include or identify a set of documents 220A-N (generally referred to as documents 220). The set of documents 220 may correspond to one or more files or a set of text defining testing parameters, requirements, and other specifications for the application 125. The set of documents 220 may include at least one test document (sometimes herein referred to as a V&V test plan documentation). The test document may identify a scheme defining execution of the test cases 205 or the corresponding test script 215. The test document may identify devices (e.g., the user device 110) to be used in the testing of the application. In addition, the test document may include or identify the strategy, scope, resources, schedule, and procedures for testing the sample application to ensure it meets requirements and specifications. The test document may include types of testing to be performed, test objectives, test environments, and criteria for entering and exiting the phases, among others. The test document may also provide information for the developers, such as a rationale supporting the sampling approach, demonstrating how it ensures adequate coverage and confidence in results, and responsibilities of each team member involved in the testing process, among others. The test document may have been manually generated by a developer for the application.

In some embodiments, the set of documents 220 may include at least one software requirement documentation (sometimes herein a requirement document). The software requirement document may identify a description of the behavior and attributes of the given application. The software requirement document may specify performance criteria for the application under certain conditions. The software requirement document may have been manually generated by a developer for the application. In some embodiments, the set of documents 220 may include at least one software design specification documentation (sometimes herein referred to as a specification document). The specification document may identify or define an architecture, components, and data flow for the given application. The specification document may have been manually generated by a developer for the application. In some embodiments, the software requirement or design documentation may be created in accordance to requirements for an entity (e.g., the software developer, regulatory agencies (e.g., United States Food & Drug Administration (USFDA), European Medicines Agency (EMA), United Kingdom's Medicines and Healthcare products Regulatory Agency (MHRA), or Japan's Pharmaceuticals and Medical Devices Agency (PMDA)), hospitals, device manufacturers, customers, or end-users) involved in the development of the sample application.

In some embodiments, the set of documents 220 may include at least one traceability table (sometimes herein referred to as traceability matrix documentation or generally as mapping). The traceability table may define or identify an association between a risk control measure and a specification for the sample application. The traceability table may identify an association between requirements of the application to corresponding test cases 205 (or test script 215). In some embodiments, the set of documents 220 may include code change history. The code change history may identify a set of modifications to the underlying code for the application. For each modification, the code change history may include a timestamp identifying when the code change occurred. For instance, the code change history may include a commit log history listing when the change to the code was committed.

In some embodiments, the set of documents 220 may include output data and at least one corresponding report for testing of the sample application. The output data may include information generated from executing the test scripts 215 for the sample application. The report may include information about execution of the test scripts 215 for the sample application. For example, the report may include an overview of the results of the testing scripts with description of what testing was performed and details regarding the results of the testing. The report may include a set of identifiers corresponding to the set of test cases 205 (or test scripts 215). For each test case 205 (or test script 215), the report may include an objective of the test, the test steps, the expected results, the actual result of the test, an indication of whether the test was a success or a failure, and information regarding anomalies or defects of the sample application found in the test, among others. In some embodiments, the report may include a traceability table may identify an association between requirements of the sample application to corresponding test cases 205 (or test script 215) as well as result of the test associated of the requirement. The report may have been previously manually generated by a developer examining the test results. In some embodiments, the report may be created in accordance requirements for an entity (e.g., the software developer, regulatory agencies, hospitals, device manufacturers, customers, or end-users) involved in the development of the sample application. The report, for example, may contain information in a particular structure for submission to a regulatory agency.

In some embodiments, at least one corpus 160 may include or identify a mapping between a feature in at least one of the test cases 205 (or corresponding scenario file) or documents 220 (e.g., the traceability mapping, requirement document, and specification document, code history) and a feature in at least one of the test scripts 215. For instance, the mapping may be between a given scenario in one of the test cases 205, with features specified in the specification document and a test script 215 to execute the test for the scenario and the features. In some embodiments, the mapping (sometimes herein referred to as label) may be among the test cases 205, the test scripts 215, or the documents 220 in the corpus 160. The mapping may be used for training the generative model 155.

In some embodiments, the model trainer 130 can produce, write, or otherwise generate at least one additional corpus 160 with which to train the generative model 155. In some embodiments, the model trainer 130 can insert, include, or otherwise add variations of the corpuses 160 retrieved from the database 120 into one or more of the set of corpora 160. The generated corpus 160 can include at least a portion of the test cases 205, at least a portion of the test packages 210, and at least a portion of the document 220, among others. In some embodiments, the model trainer 130 can generate the corpus 160 using the information extracted therefrom. For instance, the corpus 160 generated using, in part, the information from the document 220 can include a set of strings describing the purpose of the application, the instructions within the test package 210, and risk control measures of the test cases 205, among others.

With the identification, the model trainer 130 can establish or train the generative model 155 using the set of corpora 160. In some embodiments, the model trainer 130 can initialize the generative model 155. For example, the model trainer 130 can instantiate the generative model 155 by assigning random values to the weights within the layers. In some embodiments, the model trainer 130 can fine-tune a pre-trained generative model 155 (e.g., ChatGPT, LLAMA, and Stable Diffusion models) using the set of corpora 160. To train or fine-tune, the model trainer 130 can define, select, or otherwise identify at least a portion of each corpus 160 as a source set (e.g., test cases 205 and documents 220) and at least a portion of each corpus 160 as a destination set (e.g., test packages 210). In some embodiments, the model trainer 130 can select or identify the source set and the destination set using the mapping in the corpus 160. The source set may be used as input into the generative model 155 to produce an output to be compared against the destination set. The portions of each corpus 160 can at least partially overlap and may correspond to a subset of text strings or a subset of code specifying the test cases 205 and the test packages 210 within the corpus 160.

For each corpus 160, the model trainer 130 can feed or apply the strings of the source set from the corpus 160 into the generative model 155. In applying, the model trainer 130 can process the input strings in accordance with the set of layers in the generative model 155. As discussed above, the generative model 155 may include the tokenization layer, the input embedding layer, the position encoder, the encoder stack, the decoder stack, and the output layer, among others. The model trainer 130 may process the input strings (words or phrases in the form of alphanumeric characters) of the source set using the tokenizer layer of the generative model 155 to generate a set of word vectors for the input set. Each word vector may be a vector representation of at least one corresponding string in an n-dimensional feature space (e.g., using a word embedding table). The model trainer 130 may apply the set of word vectors to the input embedding layer to generate a corresponding set of embeddings. The model trainer 130 may identify a position of each string within the set of strings of the source set. With the identification, the model trainer 130 can apply the position encoder to the position of each string to generate a positional encoding for each embedding corresponding to the string and by extension the embedding.

The model trainer 130 may apply the set of embeddings along with the corresponding set of positional encodings generated from the input set of the corpus 160 to the encoder stack of the generative model 155. In applying, the model trainer 130 may process the set of embeddings along with the corresponding set of positional encodings in accordance with the layers (e.g., the attention layer and the feed-forward layer) in each encoder in the encoder block. From the processing, the model trainer 130 may generate another set of embeddings to feed forward to the encoders in the encoder stack. The model trainer 130 may then feed the output of the encoder stack to the decoder stack.

In conjunction, the model trainer 130 may process the test packages 210 (e.g., test scripts, test documents, etc.) of the destination set using a separate tokenizer layer of the generative model 155 to generate a set of word vectors for the destination set. The test package 210 of the destination set may be of the same modality as the source set of the corpus 160 or may be of a different modality as the source set of the corpus 160. Each word or code vector may be a vector representation of at least one corresponding string in an n-dimensional feature space (e.g., using a word embedding table). The model trainer 130 may apply the set of word or code vectors to the input embedding layer to generate a corresponding set of embeddings. The model trainer 130 may identify a position of each string within the set of strings of the target set. With the identification, the model trainer 130 can apply the position encoder to the position of each string to generate a positional encoding for each embedding corresponding to the string and by extension the embedding.

The model trainer 130 may apply the set of embeddings along with the corresponding set of positional encodings generated from the destination set of the corpus 160 to the decoder stack of the generative model 155. The model trainer 130 may also combine the output of the encoder stack in processing through the decoder stack. In applying, the model trainer 130 may process the set of embeddings along with the corresponding set of positional encodings in accordance with the layers (e.g., the attention layer, the encoder-decoder attention layer, the feed-forward layer) in each decoder in the decoder block. The model trainer 130 may combine the output from the encoder with the input of the encoder-decoder attention layer in the decoder block. From the processing, the model trainer 130 may generate an output set of embeddings to be fed forward to the output layer.

Continuing on, the model trainer 130 may feed the output from the decoder block into the output layer of the generative transformer layer. In feeding, the model trainer 130 may process the embeddings from the decoder block in accordance with the linear layer and the activation layer of the output layer. With the processing, the model trainer 130 may calculate probability for each embedding. The probability may represent a likelihood of occurrence for an output, given an input token. Based on the probabilities, the model trainer 130 may select an output token (e.g., test script of the test packages 210, test document of the test package 210) with the highest probability) to form, produce, or otherwise generate output 230. The output 230 can include code, instructions, test documents, test scripts, among others, or any combination thereof. The output 230 can be in the same modality as the target set of the corpus 160. While described primarily in terms of transformer model architecture, other architectures can be used for the generative model 155 to output content.

With the generation, the model trainer 130 can compare the output 230 from the generative model 155 with the destination set of the corpus 160 used to generate the output 230. The comparison can be between the probabilities (or distribution) of various tokens for the content (e.g., code within the test package 210) from the output 230 versus the probabilities of tokens in the target set of the corpus 160. For instance, the model trainer 130 can determine a difference between a probability distribution of the output 230 versus the target set of the corpus 160 to compare. The probability distribution may identify a probability for each candidate token in the output 230 or the token in the target set of the corpus 160. Based on the comparison, the model trainer 130 can calculate, determine, or otherwise generate a loss metric. The loss metric may indicate a degree of deviation of the output 230 from the expected output as defined by the target set of the corpus 160 used to generate the output 230. The loss metric may be calculated in accordance with any number of loss functions, such as a norm loss (e.g., L1 or L2), mean squared error (MSE), quadratic loss, cross-entropy loss, or Huber loss, among others.

In some embodiments, the model trainer 130 may determine the loss metric for the output 230 based on the data retrieved from the database 120. In determining, the model trainer 130 may compare the content of the output 230 with the destination set (e.g., a portion of the test package 210) to calculate a degree of similarity. The degree of similarity may measure, correspond to, or indicate, for example, a level of code similarity (e.g., using a knowledge map when comparing between test script 215 and output 230). In general, the higher the loss metric, the more the generated output test package may have deviated from the expected output corresponding to the destination set derived from the corpus 160. Conversely, the lower the loss metric, the less the generated output test package may have deviated from the expected output derived from the destination set. The loss metric may be calculated to train the generative model 155 to generate output content for test packages with a higher probability of accurate generation of test script.

Using the loss metric, the model trainer 130 can update one or more weights in the set of layers of the generative model 155. The updating of the weights may be in accordance with a back propagation and optimization function (sometimes referred to herein as an objective function) with one or more parameters (e.g., learning rate, momentum, weight decay, and number of iterations). The optimization function may define one or more parameters at which the weights of the generative model 155 are to be updated. The optimization function may be in accordance with stochastic gradient descent, and may include, for example, an adaptive moment estimation (Adam), implicit update (ISGD), and adaptive gradient algorithm (AdaGrad), among others. The model trainer 130 can iteratively train the generative model 155 until convergence. Upon convergence, the model trainer 130 can store and maintain the set of weights for the set of layers of the generative model 155 for use in inference stage.

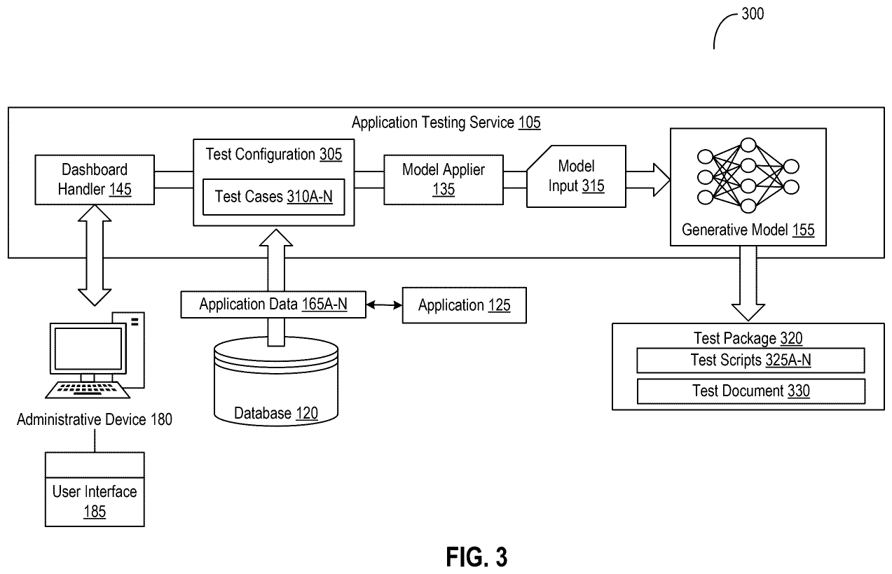

Referring now to FIG. 3, depicted is a block diagram for a process 300 to apply test configurations for an application to a generative model to generate test scripts in the system 100 for automated generation of test scripts. The process 300 may include or correspond to operations performed in the system 100 to generate test scripts using the generative model 155. Under process 300, the dashboard handler 145 on the application testing service 105 may retrieve, identify, or otherwise receive at least one test configuration 305. The test configuration 305 may define, include, or otherwise identify a set of test cases 310A-N (hereinafter generally referred to as test cases 310). The set of test cases 310 may be used to check (e.g., verify and validate) the application 125 executable on the user device 110 for addressing an indication of the user. The test cases 310 may be of a similar form as the test case 205.

Each test case 310 may include, define, or otherwise identify: at least one condition to be checked for the application 125, a result from the application 125 for the condition, or at least one criterion to determine whether the test case 205 is satisfied, among others. The condition may specify prerequisites to be met prior to carrying out the test specified by the test case 310. The result may identify an anticipated outcome of the test of the test case 310 when carried out. The criterion may be used to determine whether the test has succeeded or failed. In some embodiments, the test case 310 may include at least one traceability mapping between the test case 310 and a risk control measure for the application. In some embodiments, the test configuration 305 may identify or include a set of scenario files defining the set of test cases 310. Each scenario file (e.g., a Gherkin file) may be associated with a corresponding test case 310. Each scenario file may include, define, or otherwise identify: at least one condition to be checked for the application 125, a result from the application 125 for the condition, or at least one criterion to determine whether the test case 205 is satisfied, among others.

The test configuration 305 may also identify or include information similar in form to at least a portion of the set of documents 220 detailed herein. In some embodiments, the test configuration 305 may identify or include at least one traceability table. The traceability table may define or identify an association between a risk control measure and a specification for the sample application. The traceability table may identify an association between requirements of the application to corresponding test cases 310. In some embodiments, the test configuration 305 may identify or include code change history. The code change history may identify a set of modifications to the underlying code for the application. For each modification, the code change history may include a timestamp identifying when the code change occurred. For instance, the code change history may include a commit log history listing when the change to the code was committed.

In some embodiments, the test configuration 305 may include at least one software requirement documentation (sometimes herein a requirement document). The software requirement document may identify a description of the behavior and attributes of the given application. The software requirement document may specify performance criteria for the application under certain conditions. In some embodiments, the test configuration 305 may include at least one software design specification documentation (sometimes herein referred to as a specification document). The specification document may identify or define an architecture, components, and data flow for the given application.

In some embodiments, the dashboard handler 145 may provide at least one user interface 185 to display or present via the administrative device 180. The user interface 185 may be a graphical user interface used by a user of the administrative device 180 to enter or input information for the test configuration 305. The user interface 185 may include one or more user interface elements for acceptance or entry of the test configuration 305 or generation of test packages. For instance, the user interface 185 may be a message interface to access the functionalities of the generative model 155 to create test packages for testing (e.g., verification and validation) of the application 125. The dashboard handler 145 may receive user input defining the test configuration 305 via the user interface 185 presented on the administrative device 180. In some embodiments, the dashboard handler 145 may retrieve, identify, or otherwise receive user input defining the test cases 310 (e.g., in the form of Gherkin code) of the test configuration 305.

In some embodiments, the dashboard handler 145 may identify, retrieve, or otherwise obtain application data 165A-N (generally referred to as application data 165) from the database 120 to add into the test configuration 305. The application data 165 may identify or include information similar in form to at least a portion of the set of documents 220 detailed herein, such as the traceability table, the code change history, software requirement document, and software specification document, among others. In some embodiments, the application data 165 may include information for the model applier 135 to test each aspect of the application 125 to check the application 125 for addressing the indication of the user. Each user device 110 running the application 125 may identify a different condition. The database 120 may include application data 165 corresponding to each user of the user device 110. Using the application data 165, the dashboard handler 145 may adjust, change, or otherwise modify the test configuration 305.

Using the test configuration 305, the model applier 135 may create, produce, or otherwise generate at least one model input 315 (sometimes herein referred to as prompt). The model input 315 may include information from at least a portion of the test configuration 305. In some embodiments, the model applier 135 may generate the model input 315 using the test configuration 305 in accordance with a template. The template may include a set of predefined strings and a set of placeholders. The set of predefined strings may include, for example, a directive or command to create a particular type of output at the generative model 155, such as the text string “Please create a test package to verify and validate this feature of the application.” The set of placeholders may be for including information from the test configuration 305 at designated locations within the model input 315. Using the template, the model applier 135 may insert information from the test configuration 305 into the model input 315 at the designated locations within the model input 315.

The model applier 305 may feed, apply, or otherwise provide the model input 315 to the generative model 155. In applying, the model applier 135 can process the model input 315 using the set of layers in the generative model 155. As discussed above, the generative model 155 may include the tokenization layer, the input embedding layer, the position encoder, the encoder stack, the decoder stack, and the output layer, among others. The model applier 135 may process the input strings (code in the form of alphanumeric characters) of the model input 315 using the tokenizer layer of the generative model 155 to generate a set of word vectors (sometimes herein referred to as word tokens or tokens) for the input set. Each word vector may be a vector representation of at least one corresponding test case 310 in an n-dimensional feature space (e.g., using a word embedding table).

The model applier 135 may apply the set of word vectors to the input embedding layer to generate a corresponding set of embeddings. The model applier 135 may identify a position of each string within the set of strings of the model input 315. With the identification, the model applier 135 can apply the position encoder to the position of each string to generate a positional encoding for each embedding corresponding to the string and by extension the embedding. The model applier 135 may apply the set of embeddings along with the corresponding set of positional encodings generated from the model input 315 to the encoder stack of the generative model 155. In applying, the model applier 135 may process the set of embeddings along with the corresponding set of positional encodings in accordance with the layers (e.g., the attention layer and the feed-forward layer) in each encoder in the encoder block. From the processing, the model applier 135 may generate another set of embeddings to feed forward to the encoders in the encoder stack. The model applier 135 may then feed the output of the encoder stack to the decoder stack.

In conjunction, the model applier 135 may input an initiation input (sometimes referred to herein as a start token) using a separate tokenizer layer of the generative model 155 to generate one or more word vectors. Each word vector may be a vector representation of at least one corresponding string in an n-dimensional feature space (e.g., using a word embedding table). The model applier 135 may apply the set of word vectors to the input embedding layer to generate a corresponding set of embeddings. The model applier 135 may identify a position of each string within the set of strings of the target set. With the identification, the model applier 135 can apply the position encoder to the position of each string to generate a positional encoding for each embedding corresponding to the string and by extension the embedding.

The model applier 135 may apply the set of embeddings along with the corresponding set of positional encodings generated from the decoder stack of the generative model 155. The model applier 135 may also combine the output of the encoder stack in processing through the decoder stack. In applying, the model applier 135 may process the set of embeddings along with the corresponding set of positional encodings in accordance with the layers (e.g., the attention layer, the encoder-decoder attention layer, the feed-forward layer) in each decoder in the decoder block. The model applier 135 may combine the output from the encoder with the input of the encoder-decoder attention layer in the decoder block. From the processing, the model applier 135 may generate an output set of embeddings to be fed forward to the output layer.

Continuing on, the model applier 135 may feed the output from the decoder block into the output layer of the generative transformer layer. In feeding, the model applier 135 may process the embeddings from the decoder block in accordance with the linear layer and the activation layer of the output layer. With the processing, the model applier 135 may calculate a probability for each embedding. The probability may represent a likelihood of occurrence for an output, given an input token. Based on the probabilities, the model applier 135 may select an output token (e.g., at least a portion of output code, strings, and functions, with the highest probability) to form, produce, or otherwise generate at least a portion of the test scripts. The model applier 135 may repeat the above-described processing using the layers of the generative model 155 to form the entirety of the output.

From applying, the model applier 135 can produce, output, or otherwise generate the test package 320 for the application 125. The test package 320 may include one or more instructions to define execution of the set of test cases 310 to check the application 125. The test package may include a set of test scripts 325A-N (hereinafter generally referred to as test scripts 325). The set of test scripts 325 may be of a similar form as the test scripts 215. Each test script 325 may correspond to at least one of the test cases 310. Each test script 325 may include computer-executable instructions (e.g., JavaScript, Python, Ruby, C, C++, or PHP) to be performed by the application testing service 105 to execute the test cases 310. The test script 325 may have at least one condition to be checked for the application 125, a result from the application 125 for the condition, a set of test steps for carrying out the test case 310 associated with the test script 325, or at least one criterion to determine whether the condition of the test case 310 is satisfied. The condition may specify prerequisites to be met prior to carrying out the test specified by the corresponding test case 310. The result may identify an anticipated outcome of the test of the corresponding test case 310 when carried out. The criterion may be used to determine whether the test has succeeded or failed. The test steps may include a set of instructions (e.g., computer-executable instructions) for carrying out the corresponding test case 310. In some embodiments, the test script 325 may include instructions for checking at least one traceability mapping (or table) between the test case 310 (and a risk control measure for the application 125).

In some embodiments, based on applying the generative model 155, the generative model 155 may output, create, or otherwise generate the test package 320 to include at least one test document 330 (sometimes herein referred to as a V&V test plan documentation). The test document may identify a scheme defining execution of the test cases 205 or the corresponding test script 215. The test document may identify devices (e.g., the user device 110) to be used in the testing of the application. In addition, the test document may include or identify the strategy, scope, resources, schedule, and procedures for testing the sample application to ensure it meets requirements and specifications. The test document may include types of testing to be performed, test objectives, test environments, and criteria for entering and exiting the phases, among others.

With the generation, the model applier 135 can store and maintain an association between the test case 310 and the risk control measure of the traceability table in the database 120. The association may use one or more data structures stored on the database 120, using one or more data structures (e.g., an array, a matrix, a list, a table, a heap, or a tree) to organize the traceability table. Concurrently with the generation, the model applier 135 may transmit the test package 320 to the administrative device 180 for review by a user of the administrative device 180. The model applier 135 may send a request upon the generation of the test script to the administrative device 180. The request may identify information about the application 125, such as an application identifier (e.g., session ID, application number), network address, session tokens, API keys, session data, among others. The administrative device 180 may use the information in the request to identify and extract the application data 165 associated with the test script 325 within the database 120. Once the administrative device 180 extracts the application data 165 from the database 120, the administrative device 180 may receive the test script 325 from the model applier 135.

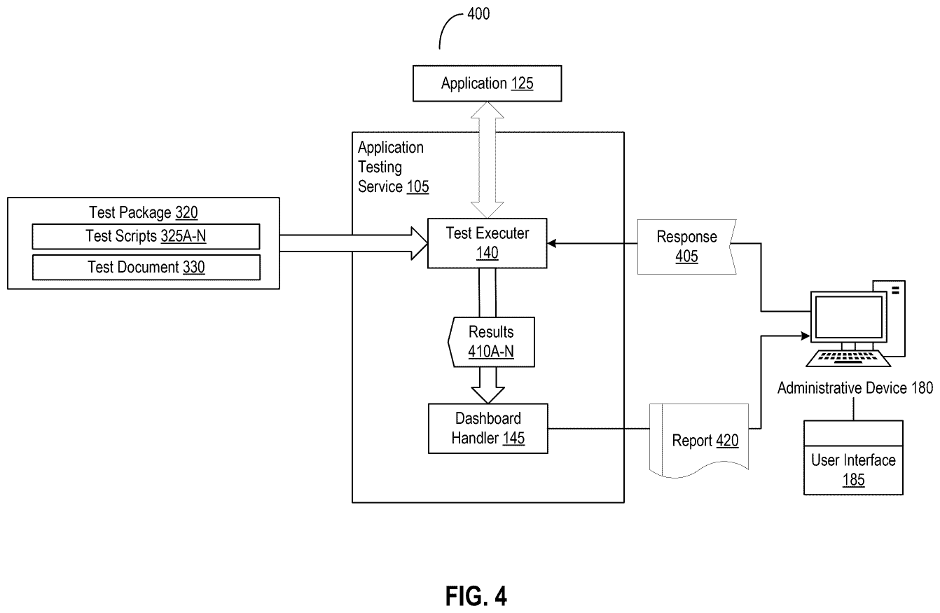

Referring now to FIG. 4, depicted is a block diagram for a process 400 to execute the test script 325 against the test cases 310 to generate a report 420 and store an association 415 in the database 120 in the system 100 for automated generation of test scripts. Under the process 400, the dashboard handler 145 may provide data associated with the test package 320 for presentation via the user interface 185 on the administrative device 180. The user interface 185 may include one or more user interface elements for selection of test packages for execution. The data may be in response to the previous input entered via the user interface 185. For example, the data may be presented in the message interface, in response to entry of information for the test configuration 305. In some embodiments, the dashboard handler 145 may provide a selection of whether to approve or reject the test package 320 (or individual test scripts 325 or the test document 330) via the user interface 185. The dashboard handler 145 may retrieve, identify, or otherwise receive a selection 405 of one of approval or rejection of the test package 320 from the administrative device 180 through the user interface 185. For example, upon review of the test script 325 and the test document 330, the user of the administrative device 180 may interact with the user interface 185 to select approval or rejection of the test package 320.

The test executor 140 on the application testing service 105 may perform, carry out, or otherwise execute the set of test scripts 325 of the test package 320. In some embodiments, the test executor 140 may execute the set of test scripts 325, in response to the selection 405 identifying the approval of the test package 320 (or the individual test scripts 325 or the test document 330). Conversely, the test executor 140 may refrain from executing the set of test scripts 325, in response to the selection 405 identifying the approval of the test package 320 (or the individual test scripts 325 or the test document 330). In some embodiments, to execute the set of test scripts 325, the test executor 140 may launch or execute the application 125 (e.g., in a test environment, a virtual machine, or the user device 110). The application 125 may be executed in an environment specified by the test package 320. For example, if the test document 330 indicates that the application 125 is to be tested on a mobile device, the test executor 140 may invoke an emulator to instantiate a test environment for the mobile device.

For each test script 325, the test executor 140 may determine whether the condition of the test script 325 has been satisfied while running the application 125. When the condition is satisfied, the test executor 140 may perform the set of test steps defined by the test script 325 on the application 125. The test executor 140 may produce, create, or otherwise generate at least one output from executing the test script 325 on the application 125. The test executor 140 may compare the output with the expected results of the test script 325 in accordance with the criteria. Based on the comparison, the test executor 140 may generate at least one result 410A-N (hereinafter generally referred to as result 410) for the test script 325.

When the output satisfies the criteria, the test executor 140 may generate the result 410 to indicate success. Otherwise, when the output does not satisfy the criteria, the test executor 140 may generate the result 410 to indicate failure. In some embodiments, the test executor 140 may determine whether the application 125 performed in accordance with the traceability mapping defined by the test script 325. For example, the test executor 140 may determine whether the application 125 successfully invoked a communication feature with a remote service as a risk control measure, when the inputs fed to the application 125 indicate an anomaly or emergency. When the output satisfies the traceability mapping, the test executor 140 may generate the result 410 to indicate success. Otherwise, when the output does not satisfy the traceability mapping, the test executor 140 may generate the result 410 to indicate failure. The test executor 140 may traverse through the set of test scripts 325 in the test package 320 to generate the set of results 410.

The dashboard handler 145 may generate, create, or otherwise create at least one report 420 based on the results 410. The report 420 may identify or indicate the result 410 for each test case 305 of the test configuration 305 or each script 325 of the test package 320. In some embodiments, the dashboard handler 145 may generate the report 420 using the results 410 in accordance with a template for creating reports. In some embodiments, the dashboard handler 145 may invoke the model applier 135 to feed, apply, or otherwise provide the results 410 to the generative model 155. The model applier 135 may generate a model input using the results 410 in accordance with a template for prompts for the generative model 155 to create reports. For example, the template may include the phrase, “Please use the following test results to create a report in accordance with the requirements of XYZ board.” The model input may also include at least a portion of the test configuration 305 or the test package 320. The application of the generative model 155 may be similar as detailed herein.

By applying the generative model 155, the model applier 135 may generate an output to be used as the report 420. The report 420 may include or identify an overview of the results of the testing scripts 325. The overview may include a description of what testing was performed and details regarding the results of the testing. The report 420 may include a set of identifiers corresponding to the set of test cases 310 (or test scripts 325). For each test case 310 (or test script 325), the report 420 may identify or include an objective of the test, the test steps, the expected results, the actual result of the test, an indication of whether the test was a success or a failure, and information regarding anomalies or defects of the sample application found in the test, among others. In some embodiments, the report 420 may include a traceability table that may identify an association between requirements of the sample application to corresponding test cases 310 (or test script 325) as well as results of the test associated with the requirement. In some embodiments, the report 420 may be created in accordance to requirements for an entity (e.g., the software developer, regulatory agencies, hospitals, device manufacturers, customers, or end-users) as specified in the model input. The report, for example, may contain information in a particular structure for submission to a regulatory agency.

With the generation of the report 420, the dashboard handler 145 may send, transmit, or otherwise provide the report 420 for presentation on the administrative device 180 via the user interface 185. The user interface 185 may include one or more user interface elements for presentation or generation of outputs (e.g., reports) from the execution of the test packages. The report 420 may include a format readable by the administrative device 180, such as HTML, XML, JSON, PDF, Word, among others. To generate the format, the dashboard handler 145 may receive a desired format from the administrative device 180 for presentation in the user interface of the administrative device 180. Upon reception of the desired format, the dashboard handler 145 may execute one or more APIs to generate or prepare the report 420 in the desired format of the administrative device 180. In some embodiments, the dashboard handler 145 may include using a built-in reporter of the test executer 140 to generate the reports 420 of the test cases 310.

In some embodiments, the dashboard handler 145 may communicate with an external application or computing system to provide the outputs of the generative model 155. The output may include, for example, the test script 325, the test documentation 330, or the report 420, among others. For instance, the dashboard handler 145 may provide the test document 330 and the report 420 to a computing system associated with a third-party entity (e.g., a regulatory agency, a hospital, a pharmaceutical provider, a device manufacturer, a customer, or end-users). The submission of the test document 330 and the report 420 may be part of a clearance or approval process for the application 125. The provision may be in response to an invocation of a function of the API or an interaction with the user interface 185 on the administrative device 180.

In some embodiments, the dashboard handler 145 may generate, create, or otherwise create at least one association. In some embodiments, the dashboard handler 145 may generate the association between the application 125 and the test package 320. In some embodiments, the dashboard generator may generate the association between the test script 325 and the results 410. The association may be stored within a data structure to maintain a connection between the results 410 and the test script 325 and between the application 125 and the test package 320, respectively. For instance, the data structure can be a linked list where the head of the list is the application 125 with a pointer to the test package 320. In another instance, the data structure can be a tree where the head of the tree is the results 410 and a child node is the test script 325. Upon generation of the association, the dashboard handler 145 may store the association within the database 120 for access by the administrative device 180.

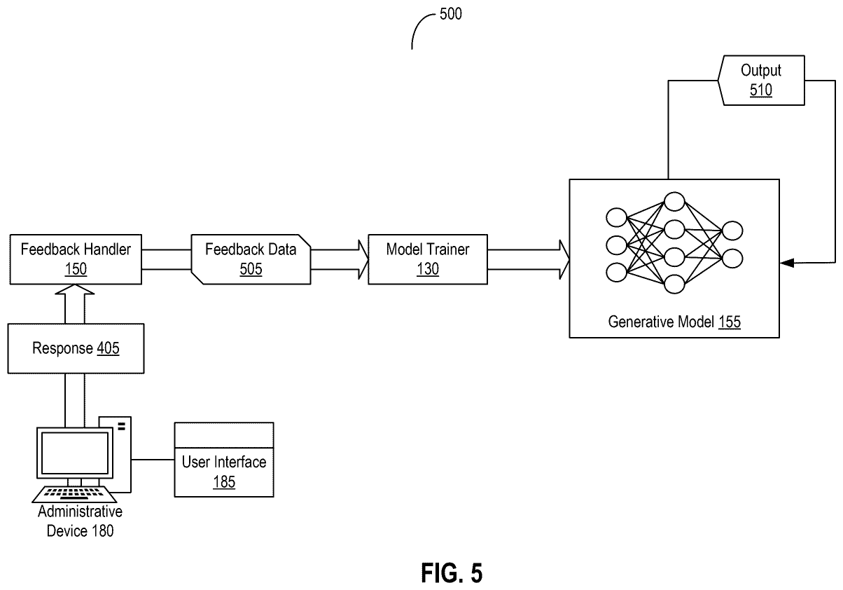

Referring now to FIG. 5, depicted is a block diagram for a process 500 to update the generative transformer models in the system for automated generation of test scripts. The process 500 may include or correspond to operations to derive feedback data 505 gathered from the selection 405 to update the generative model 155. Under process 500, the feedback handler 150 executing on the application testing service 105 may retrieve, identify, or otherwise receive the selection 405 from the user device 110. The selection 405 may identify a rejection of the test package 320 (or the individual test scripts 325 or test document 330). The selection 405 may also identify or include modifications to the test package 320.

Based on the selection 405, the feedback handler 150 may produce, create, or otherwise generate feedback data 505. In some embodiments, the feedback handler 150 may generate the feedback data 505 for subsequent generation of test scripts 325 and test packages 320 by the generative model 155. In some embodiments, the feedback data 505 may identify or include information to be used as one or more parameters defining subsequent test scripts to be generated and used for the test cases. For example, for subsequent test scripts, the model trainer 130 may insert the feedback data 505 into one or more test packages 320 to generate a new test script to feed to the generative model 155. The feedback data 505 may indicate or include whether test script 325 was approved or rejected by the administrative device 180. Upon generation, the feedback handler 150 may store and maintain an association between the feedback data 505 and the test script on the database 120.

In some embodiments, the feedback handler 150 may generate the feedback data 505 to include information to be used to update the weights of the generative model 155. In some embodiments, the feedback handler 150 may generate the feedback data 505 in a similar format as the corpus 160 described above. The feedback data 505 may be generated to include the contents of the test scripts and the information from the selection 405. In some embodiments, the feedback handler 150 may calculate, generate, or otherwise determine a performance metric identifying or corresponding to effectiveness of the test scripts to include as part of the feedback data 505. The performance measure may indicate a degree to which the presented test scripts include instructions to execute each test case 310 for the application 125. In general, more indications 405 with approval of the test scripts may result in a higher performance measure. In contrast, more indications 405 with rejections of the test scripts may result in a lower performance measure. Upon generation, the feedback handler 150 may include the performance metrics and the contents of the test scripts into the feedback data 505.

In some embodiments, the feedback data 505 may identify a modification to the test script 325 based on the selection 405. The modification may represent a change, deletion, or addition to the code of the test script 325, a revision to the test document 330, among others. In some embodiments, modifications to the code may prevent the wasting of the test script. For instance, test scripts 320 with a high number of modifications may indicate that the test script 325 was rejected, however, with the modification, the test script can be used to improve the generative model 155. In this manner, there can be a significant reduction in wasted computing resources by recycling generated test scripts to update and fine tune the generative model 155.

In some embodiments, the feedback handler 150 may apply sentiment analysis to the information included in the selection 405 (e.g., the data inputted by the administrative device 180) to generate the performance metric. The sentiment analysis may be performed using natural language processing (NLP) techniques, such as lexicon analysis for sentiment related words, a support vector machine (SVM), linear regression, or Naïve Bayesian model, among others. The feedback handler 150 may apply the sentiment analysis algorithm to the selection 405 to recognize, detect, or otherwise identify a sentiment of the user with respect to the presented test scripts. The sentiment may include, for example, positive, negative, or neutral selections 405, among others. Using the identified sentiment, the feedback handler 150 may assign a value to the performance metric. For example, when the sentiment is positive, the feedback handler 150 may assign a high value. When the sentiment is negative, the feedback handler 150 may assign a low value. When the sentiment is neutral, the feedback handler 150 may assign an intermediate value.

The model trainer 130 may use the feedback data 505 to modify, adjust, or otherwise update the weights of the generative model 155. The feedback data 505 may be aggregated over multiple test packages 320 from multiple applications 125. In general, the model trainer 130 may update the weights to credit production of test scripts 325 with high performance metrics and punish outputting of test script 325 with lower performance metrics. The training or fine-tuning of the generative model 155 using the feedback data 505 may be similar to the training or fine-tuning using the set of corpora 160 described above. To train, the model trainer 130 may define, select, or otherwise identify at least a portion of each feedback data 505 as a source set and at least a portion of each feedback data 505 as a destination set. The source set may be used as input into the generative model 155 to produce an output to be compared against the destination set. The portions of each feedback data 505 can at least partially overlap and may correspond to a subset of text strings within the feedback data 505.

The model trainer 130 can feed or apply the strings of the source set from the feedback data 505 into the generative model 155. In applying, the model trainer 130 can process the input strings in accordance with the set of layers in the generative model 155. As discussed above, the generative model 155 may include the tokenization layer, the input embedding layer, the position encoder, the encoder stack, the decoder stack, and the output layer, among others. The model trainer 130 may process the input strings (words or phrases in the form of alphanumeric characters) of the source set using the tokenizer layer of the generative model 155 to generate a set of word vectors for the input set. Each word vector may be a vector representation of at least one corresponding string in an n-dimensional feature space (e.g., using a word embedding table). The model trainer 130 may apply the set of word vectors to the input embedding layer to generate a corresponding set of embeddings. The model trainer 130 may identify a position of each string within the set of strings of the source set. With the identification, the model trainer 130 can apply the position encoder to the position of each string to generate a positional encoding for each embedding corresponding to the string and by extension the embedding.

The model trainer 130 may apply the set of embeddings along with the corresponding set of positional encodings generated from the input set of the feedback data 505 to the encoder stack of the generative model 155. In applying, the model trainer 130 may process the set of embeddings along with the corresponding set of positional encodings in accordance with the layers (e.g., the attention layer and the feed-forward layer) in each encoder in the encoder block. From the processing, the model trainer 130 may generate another set of embeddings to feed forward to the encoders in the encoder stack. The model trainer 130 may then feed the output of the encoder stack to the decoder stack.

In conjunction, the model trainer 130 may process the data (e.g., test scripts 325, test documents 330) of the destination set using a separate tokenizer layer of the generative model 155 to generate a set of word vectors for the destination set. The data of the destination set may be of the same modality as the source set of the feedback data 505 or may be of a different modality as the source set of the feedback data 505. Each word vector may be a vector representation of at least one corresponding string in an n-dimensional feature space (e.g., using a word embedding table). The model trainer 130 may apply the set of word vectors to the input embedding layer to generate a corresponding set of embeddings. The model trainer 130 may identify a position of each string within the set of strings of the target set. With the identification, the model trainer 130 can apply the position encoder to the position of each string to generate a positional encoding for each embedding corresponding to the string and by extension the embedding.

The model trainer 130 may apply the set of embeddings along with the corresponding set of positional encodings generated from the destination set of the feedback data 505 to the decoder stack of the generative model 155. The model trainer 130 may also combine the output of the encoder stack in processing through the decoder stack. In applying, the model trainer 130 may process the set of embeddings along with the corresponding set of positional encodings in accordance with the layers (e.g., the attention layer, the encoder-decoder attention layer, the feed-forward layer) in each decoder in the decoder block. The model trainer 130 may combine the output from the encoder with the input of the encoder-decoder attention layer in the decoder block. From the processing, the model trainer 130 may generate an output set of embeddings to be fed forward to the output layer.

Continuing on, the model trainer 130 may feed the output from the decoder block into the output layer of the generative transformer layer. In feeding, the model trainer 130 may process the embeddings from the decoder block in accordance with the linear layer and the activation layer of the output layer. With the processing, the model trainer 130 may calculate a probability for each embedding. The probability may represent a likelihood of occurrence for an output, given an input token. Based on the probabilities, the model trainer 130 may select an output token (e.g., at least a portion of the test script or the test document with the highest probability) to form, produce, or otherwise generate the output 510. The output 510 can include the test package 320, the test script 325, or the test document 330. The output 510 can be in the same modality as the target set of the feedback data 505.

With the generation, the model trainer 130 can compare the output 510 from the generative model 155 with the destination set of the feedback data 505 used to generate the output 510. The comparison can be between the probabilities (or distribution) of various tokens for the content from the output 510 versus the probabilities of tokens in the target set of the feedback data 505. For instance, the model trainer 130 can determine a difference between a probability distribution of the output 510 versus the target set of the feedback data 505. The probability distribution may identify a probability for each candidate token in the output 510 or the token in the target set. Based on the comparison, the model trainer 130 can calculate, determine, or otherwise generate a loss metric. The loss metric may indicate a degree of deviation of the output 510 from the expected output as defined by the target set of the feedback data 505 used to generate the output 510. The loss metric may be calculated by in accordance with any number of loss functions, such as a norm loss (e.g., L1 or L2), a mean squared error (MSE), a quadratic loss, a cross-entropy loss, and a Huber loss, among others.

In some embodiments, the model trainer 130 may determine the loss metric for the output 510 based on the performance measures determined for each test script. In determining, the model trainer 130 may compare the content of the output 510 with the test package 210 to calculate a degree of similarity. The degree of similarity may measure, correspond to, or indicate, for example, a level of code similarity (e.g., using a knowledge map when comparing between code of the test package 210 and output 510). The loss metric may be a function of the degree of similarity and the performance measure, among others. In general, the higher the loss metric, the more the generated output 510 may have deviated away from test scripts 325 with higher performance metrics and closer to test scripts 325 with lower performance metrics. Conversely, the lower the loss metric, the less the generated output 510 may be similar to test scripts 325 with higher performance metrics and deviated from test scripts 325 with lower performance metric. The loss metric may be calculated to train the generative model 155 to generate output content for messages with a higher probability of engagement by the user.

Using the loss metric, the model trainer 130 can update one or more weights in the set of layers of the generative model 155. The updating of the weights may be in accordance with back propagation and optimization function (sometimes referred to herein as an objective function) with one or more parameters (e.g., learning rate, momentum, weight decay, and number of iterations). The optimization function may define one or more parameters at which the weights of the generative model 155 are to be updated. The model trainer 130 can iteratively train the generative model 155 until convergence. Upon convergence, the model trainer 130 can store and maintain the set of weights for the set of layers of the generative model 155 for use.

In some embodiments, the model trainer 130 may change, alter, or otherwise modify the template used to generate model inputs for the generative model 155 using the selection 405. For example, the selection 405 may identify at least a portion of the model input 315 outside the portion corresponding to the test configuration 305, to be modified, among others. The modification of the template may be independent of the updating of the generative model 155. Using the selection 405, the model trainer 130 may change the template used to generate model inputs. The model trainer 130 may store and maintain the template for future use in generating model inputs for the generative model 155.

In this manner, the application testing service 105 may significantly improve the reliability, quality, and overall performance of the resulting application 125 through the testing process. The application testing service 105 may provide for testing of the application 125 from testing design to quality assurance and control through the user interface 185. Before the outset, the generative model 155 may be trained and fine-tuned for the testing process and used to create the test package 320 containing the test scripts 325 and the test documents 330. As a result, there may be a reduction in the occurrence of discrepancies between the test document 330 and script 325. The reduction of discrepancies may ensure that functionalities, user interface design, performance, compliance, and security features of the application 125 are properly tested for. During the testing stage, the generative model 155 may be provided with the test configuration 305 to create the test package 325 for application 125 to drastically reduce the amount of time and effort taken in testing the application 125. This may allow for speedier V&V testing and quicker roll out of the application 125 to user devices 110. The application 125 can be more quickly and reliably tested for its capabilities and improving the quality of human-computer interactions (HCl) between the user and the application 125. In the context of digital therapeutics, the application 125 may be rolled out to users faster, thereby providing end users access to therapeutic interventions that can address the symptoms related to medical disease, conditions, symptoms, indications, thereby improving health outcomes and quality of life.

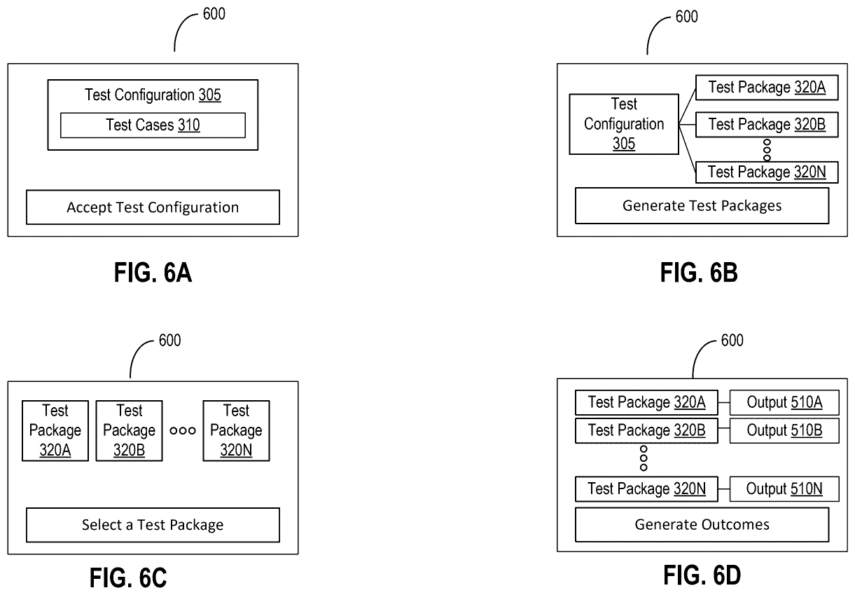

Referring now to FIGS. 6A-6D depicted are examples of a dashboard user interface 600 to accept a test configuration, generate test packages, select test packages, and generate outcomes for display on the administrative device 180. The dashboard handler 145 may generate, create, or otherwise provide the user interface 600 for the administrative device 180. The interface 600 may be provided prior to the process 200 or during any subsequent process described herein. The user interface 600 may control the steps of each process described herein. For instance, upon creation of the test configuration 305, the dashboard handler 145 may provide the user interface 600 to accept the test configuration 305, as shown in FIG. 6A. Continuing on, the dashboard handler 145 may provide the user interface 600 to generate one or more test packages 320A-N, as shown in FIG. 6B. From here, the dashboard handler 145 may provide the user interface 600 to select one or more of the generated test packages 320, as shown in FIG. 6C. Furthermore, the dashboard handler 145 may provide the user interface 600 to generate outputs 510 based on the selected test packages 320.

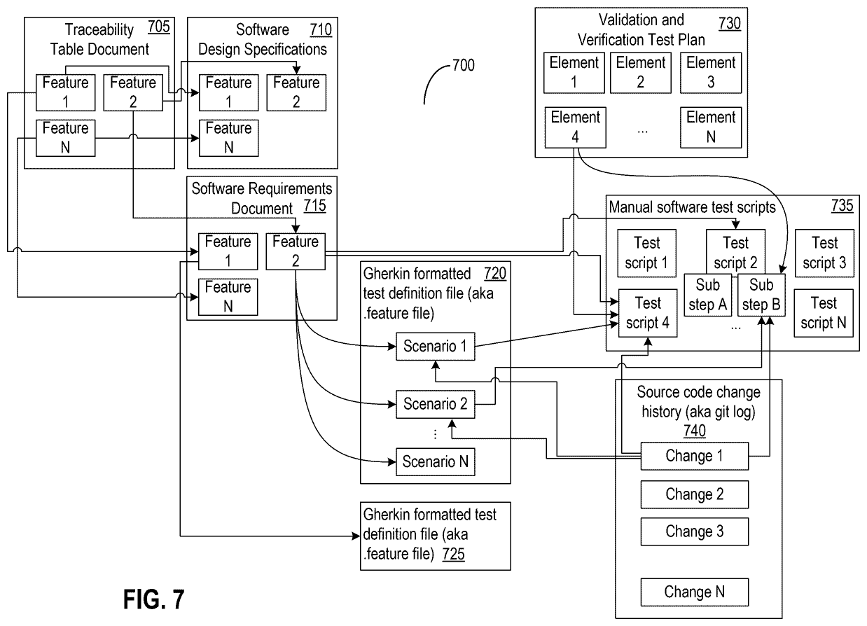

Referring now to FIG. 7 depicted is a flow diagram of a process 700 to tag training data (i.e., corpora 160) for the generative model 155. The process 700 begins by exporting relevant data for the generative model 155 using a tractability table document 705, software design specification 710 and software requirement documents 715. Each may include a plurality of features to define a plurality of scenarios, for the test scripts 735, within a Gherkin test file 720. Each scenario may correspond to a Behavior-Driven Development (BDD) test using keywords, such as Given, When, and Then in accordance with Gherkin to describe a context, an action, and an expected outcome. In this manner, each scenario gives guidance on how the feature of the application should behave when executing a test case against a test script. Each test script may use a plurality of elements from a Validation and Verification test plan 730. Each element may correspond with one or more test scripts 735 to verify and validate the instructions within the test scripts 735. In this manner, the training data may use verified and validated instructions when training the generative model 155. Lastly, the steps of the test script 735 may factor a code change history 740. A test script 735 may include a plurality of steps which define each change of code or previous versions of the application 125. In this manner, the test script 725 may execute on older version of the application 125.

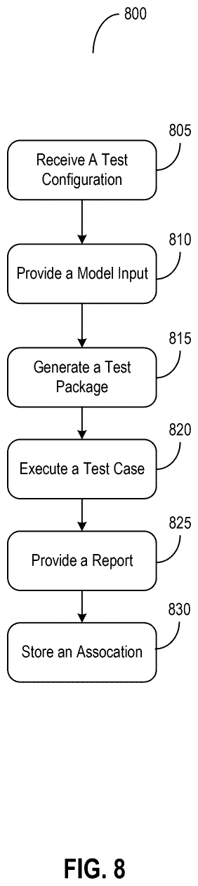

Referring now to FIG. 8, depicted is a method 800 for automated generation of test scripts for verifying and validating digital therapeutics applications. The method 800 can be implemented or performed using any of the components detailed herein such as the application testing service 105, the user device 110, and the database 120, among others. Under method 800, a computing system (e.g., administrative device 180, application testing service 105) may receive a test configuration (805). The computing system may provide a model input with the test configuration (810). The computing system may generate a test package using the model input (815). The computing system may execute a test case using the test package (820). The computing system may provide a report of the output from the executes test case (825). The computing system may store an association in a database (830).

### B. Network and Computing Environment

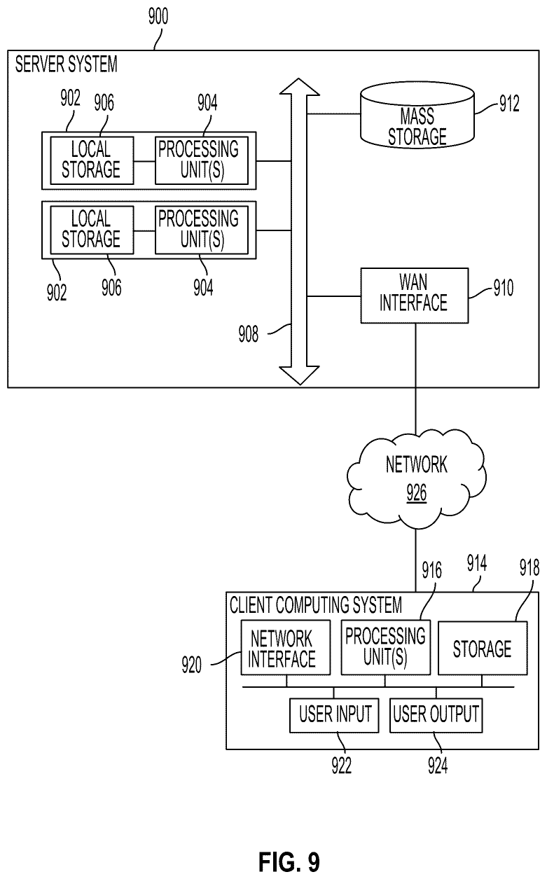

Various operations described herein can be implemented on computer systems. FIG. 9 shows a simplified block diagram of a representative server system 900, client computer system 914, and network 926 usable to implement certain embodiments of the present disclosure. In various embodiments, server system 900 or similar systems can implement services or servers described herein or portions thereof. Client computer system 914 or similar systems can implement clients described herein. The system 100 described herein can be like the server system 900. Server system 900 can have a modular design that incorporates a number of modules 902 (e.g., blades in a blade server embodiment); while two modules 902 are shown, any number can be provided. Each module 902 can include processing unit(s) 904 and local storage 906.

Processing unit(s) 904 can include a single processor, which can have one or more cores, or multiple processors. In some embodiments, processing unit(s) 904 can include a general-purpose primary processor as well as one or more special-purpose co-processors, such as graphics processors, digital signal processors, or the like. In some embodiments, some or all processing units 904 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 904 can execute instructions stored in local storage 906. Any type of processors in any combination can be included in processing unit(s) 904.

Local storage 906 can include volatile storage media (e.g., DRAM, SRAM, SDRAM, or the like) and/or non-volatile storage media (e.g., magnetic, or optical disk, flash memory, or the like). Storage media incorporated in local storage 906 can be fixed, removable, or upgradeable as desired. Local storage 906 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 904 need at runtime. The ROM can store static data and instructions that are needed by processing unit(s) 904. The permanent storage device can be a non-volatile read-and-write memory device that can store instructions and data even when module 902 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some embodiments, local storage 906 can store one or more software programs to be executed by processing unit(s) 904, such as an operating system and/or programs implementing various server functions such as functions of the system 100 or any other system described herein, or any other server(s) associated with system 100 or any other system described herein.

“Software” refers generally to sequences of instructions that, when executed by processing unit(s) 904, cause server system 900 (or portions thereof) to perform various operations, thus defining one or more specific machine embodiments that execute and perform the operations of the software programs. The instructions can be stored as firmware residing in read-only memory and/or program code stored in non-volatile storage media that can be read into volatile working memory for execution by processing unit(s) 904. Software can be implemented as a single program or a collection of separate programs or program modules that interact as desired. From local storage 906 (or non-local storage described below), processing unit(s) 904 can retrieve program instructions to execute and data to process to execute various operations described above.

In some server systems 900, multiple modules 902 can be interconnected via a bus or other interconnect 908, forming a local area network that supports communication between modules 902 and other components of server system 900. Interconnect 908 can be implemented using various technologies, including server racks, hubs, routers, etc.

A wide area network (WAN) interface 910 can provide data communication capability between the local area network (e.g., through the interconnect 908) and the network 926, such as the Internet. Other technologies can be used to communicatively couple the server system with the network 926, including wired (e.g., Ethernet, IEEE 802.3 standards) and/or wireless technologies (e.g., Wi-Fi, IEEE 802.11 standards).

In some embodiments, local storage 906 is intended to provide working memory for processing unit(s) 904, providing fast access to programs and/or data to be processed while reducing traffic on interconnect 908. Storage for larger quantities of data can be provided on the local area network by one or more mass storage subsystems 912 that can be connected to interconnect 908. Mass storage subsystem 912 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 912. In some embodiments, additional data storage resources may be accessible via WAN interface 910 (potentially with increased latency).

Server system 900 can operate in response to requests received via WAN interface 910. For example, one of modules 902 can implement a supervisory function and assign discrete tasks to other modules 902 in response to received requests. Work allocation techniques can be used. As requests are processed, results can be returned to the requester via WAN interface 910. Such operation can generally be automated. Further, in some embodiments, WAN interface 910 can connect multiple server systems 900 to each other, providing scalable systems capable of managing high volumes of activity. Other techniques for managing server systems and server farms (collections of server systems that cooperate) can be used, including dynamic resource allocation and reallocation.

Server system 900 can interact with various user-owned or user-operated devices via a wide-area network such as the Internet. An example of a user-operated device is shown in FIG. 9 as client computing system 914. Client computing system 914 can be implemented, for example, as a consumer device such as a smartphone, other mobile phone, tablet computer, wearable computing device (e.g., smart watch, eyeglasses), desktop computer, laptop computer, and so on. For example, client computing system 914 can communicate via WAN interface 920. Client computing system 914 can include computer components such as processing unit(s) 916, storage device 918, network interface 920, user input device 922, and user output device 924. Client computing system 914 can be a computing device implemented in a variety of form factors, such as a desktop computer, laptop computer, tablet computer, smartphone, other mobile computing device, wearable computing device, or the like.

Processing unit 916 and storage device 918 can be similar to processing unit(s) 904 and local storage 906 described above. Suitable devices can be selected based on the demands to be placed on client computing system 914; for example, client computing system 914 can be implemented as a “thin” client with limited processing capability or as a high-powered computing device. Client computing system 914 can be provisioned with program code executable by processing unit(s) 916 to enable various interactions with server system 900.

Network interface 920 can provide a connection to the network 926, such as a wide area network (e.g., the Internet) to which WAN interface 910 of server system 900 is also connected. In various embodiments, network interface 920 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 922 can include any device (or devices) via which a user can provide signals to client computing system 914; client computing system 914 can interpret the signals as indicative of user requests or information. In various embodiments, user input device 922 can include at least one of a keyboard, touch pad, touch screen, mouse, or other pointing device, scroll wheel, click wheel, dial, button, switch, keypad, microphone, and so on.

User output device 924 can include any device via which client computing system 914 can provide information to a user. For example, user output device 924 can include display-to-display images generated by or delivered to client computing system 914. The display can incorporate various image generation technologies, e.g., a liquid crystal display (LCD), light-emitting diode (LED) display including organic light-emitting diodes (OLED), projection system, cathode ray tube (CRT), or the like, together with supporting electronics (e.g., digital-to-analog or analog-to-digital converters, signal processors, or the like). Some embodiments can include a device such as a touchscreen that function as both input and output device. In some embodiments, other user output devices 924 can be provided in addition to or instead of a display. Examples include indicator lights, speakers, tactile “display” devices, printers, and so on.

Some embodiments include electronic components, such as microprocessors, storage, and memory that store computer program instructions in a computer readable storage medium. Many of the features described in this specification can be implemented as processes that are specified as a set of program instructions encoded on a computer readable storage medium. When one or more processing units execute these program instructions, they cause the processing unit(s) to perform various operations indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 904 and 916 can provide various functionality for server system 900 and client computing system 914, including any of the functionality described herein as being performed by a server or client, or other functionality.

It will be appreciated that server system 900 and client computing system 914 are illustrative and that variations and modifications are possible. Computer systems used in connection with embodiments of the present disclosure can have other capabilities not specifically described here. Further, while server system 900 and client computing system 914 are described with reference to particular blocks, it is to be understood that these blocks are defined for convenience of description and are not intended to imply a particular physical arrangement of component parts. For instance, different blocks can be but need not be in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present disclosure can be realized in a variety of apparatus including electronic devices implemented using any combination of circuitry and software.

While the disclosure has been described with respect to specific embodiments, one skilled in the art will recognize that numerous modifications are possible. Embodiments of the disclosure can be realized using a variety of computer systems and communication technologies, including but not limited to specific examples described herein. Embodiments of the present disclosure can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may refer to specific hardware and software components, those skilled in the art will appreciate that different combinations of hardware and/or software components may also be used and that particular operations described as being implemented in hardware might also be implemented in software or vice versa.

Computer programs incorporating various features of the present disclosure may be encoded and stored on various computer readable storage media; suitable media include magnetic disk or tape, optical storage media such as compact disk (CD) or digital versatile disk (DVD), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the disclosure has been described with respect to specific embodiments, it will be appreciated that the disclosure is intended to cover all modifications and equivalents within the scope of the following claims.

1. A method of generating test packages to evaluate applications, comprising:
receiving, by one or more processors, a test configuration comprising a plurality of test cases to evaluate an application executable on a user device for addressing an indication of a user;
providing, by the one or more processors, a model input generated using the test configuration to a generative model, wherein the generative model is established using a plurality of corpuses, each of the plurality of corpuses comprising (i) a respective plurality of test cases to evaluate a respective application and (ii) a respective test package comprising (a) a respective test specification corresponding to execution of the respective plurality of test cases and (b) a respective test script defining execution of the respective plurality of test cases and comprising computer-executable instructions;
generating, by the one or more processors, based on providing the model input to the generative model, a test package comprising (i) a test specification corresponding to execution of the plurality of test cases and (ii) a test script defining execution of the plurality of test cases to evaluate the application, the test script comprising computer-executable instructions that, when executed, cause the application to be evaluated using at least one of the plurality of test cases to generate a report comprising an expected result for at least one of the plurality of test cases;
executing, by the one or more processors, the computer-executable instructions of the test script to evaluate the application in accordance with the test specification;
generating, by the one or more processors, the report comprising the expected result for at least one of the plurality of test cases and an association between one or more requirements of the application to at least one corresponding test case and a result of the test corresponding with the requirement;
providing, by the one or more processors, a user interface including at least one of: (i) a user interface to accept the test configuration, (ii) a user interface to generate one or more test packages, (iii) a user interface to select from the one or more test packages for execution, (iv) a user interface to generate outputs using the execution of the one or more test packages, or (v) a user interface to provide a report generated based on the execution of the one or more test packages to a remote device;
receiving, by the one or more processors, a response via the user interface;
storing, by the one or more processors, a data structure corresponding to the report and the response;
wherein the data structure comprises an association based on the report and the response, the association comprising an identifier corresponding to a second test script or second test package;
wherein the test script and second test script are at least one of a same test script or a different test script; and
wherein the test package and second test package are at least one of a same test package or a different test package.

2. The method of claim 1, wherein the test configuration comprises (i) a scenario file defining a condition to test the application and the expected result from the application for at least one of the plurality of test cases, and (ii) a traceability table defining an association between a risk control measure and a specification for the application.

3. The method of claim 2, wherein the test configuration comprises at least one of: (iii) a specification document comprising a function to be executable by the application, or (iv) a code history comprising a modification to a code for the application.

4. (canceled)

5. The method of claim 1, wherein generating the test package further comprises generating the test script having the computer-executable instructions comprising, for at least one test case of the plurality of test cases: (i) a condition for the application, (ii) the expected result from the application for the respective condition, (iii) a criterion against which to determine whether the at least one test case is satisfied, and (iv) a traceability mapping between the at least one test case and a risk control measure.

6.-7. (canceled)

8. The method of claim 1, further comprising receiving, by the one or more processors, via the user interface, a selection of one of approval or rejection of the test script, and
wherein executing the computer-executable instructions further comprises executing the computer-executable instructions based on the selection comprising approval of the test script.

9. The method of claim 1, further comprising:
receiving, by the one or more processors, feedback data comprising a modification to a test script; and
updating, by the one or more processors, at least one of a plurality of weights of the generative model using the feedback data.

10. The method of claim 1, wherein receiving the test configuration further comprises receiving, via the user interface, a user input defining the plurality of test cases of the test configuration, and further comprising:
providing, by the one or more processors, via the user interface, data associated with the test package.

11. (canceled)

12. The method of claim 1, wherein at least one of the plurality of corpuses includes a mapping between (i) a feature in at least one of (a) a respective scenario file, (b) a respective traceability table, (c) a specification document, or (d) a code history, with (ii) a feature in a respective test script,
wherein at least one of the plurality of test cases identifies a risk control measure for the application to be evaluated.

13. The method of claim 1, wherein the user is administered with a medication to address the indication, concurrently with provision of the application.

14. A system of generating test packages to evaluate applications, comprising:
one or more processors coupled with memory, the one or more processors configured to:
receive a test configuration comprising a plurality of test cases to evaluate an application executable on a user device for addressing an indication of a user;
provide a model input generated using the test configuration to a generative model, wherein the generative model is established using a plurality of corpuses, each of the plurality of corpuses comprising (i) a respective plurality of test cases to evaluate a respective application and (ii) a respective test package comprising (a) a respective test specification corresponding to execution of the respective plurality of test cases and (b) a respective test script defining execution of the respective plurality of test cases and comprising computer-executable instructions;
generate based on providing the model input to the generative model, a test package comprising (i) a test specification corresponding to execution of the plurality of test cases and (ii) a test script defining execution of the plurality of test cases to evaluate the application, the test script comprising computer-executable instructions that, when executed, cause the application to be evaluated using at least one of the plurality of test cases to generate a report comprising an expected result for least one of the plurality of test cases;
execute the computer-executable instructions of the test script to evaluate the application in accordance with the test specification;
generate the report comprising the expected result for least one of the plurality of test cases and an association between one or more requirements of the application to corresponding test cases and a result of the test associated with the requirement
provide a user interface including at least one of: (i) a user interface to accept the test configuration, (ii) a user interface to generate one or more test packages, (iii) a user interface to select from the one or more test packages for execution, (iv) a user interface to generate outputs using the execution of the one or more test packages, or (v) a user interface to provide a report generated based on the execution of the one or more test packages to a remote device;
receive a response via the user interface;
store a data structure corresponding to the report and the response;
wherein the data structure comprises an association based on the report and the response, the association comprising an identifier corresponding to a second test script or second test package;
wherein the test script and second test script are at least one of a same test script or a different test script; and
wherein the test package and second test package are at least one of a same test package or a different test package.

15. The system of claim 14, wherein the test configuration comprises (i) a scenario file defining a condition to test the application and the expected result from the application for at least one of the plurality of test cases, and (ii) a traceability table defining an association between a risk control measure and a specification for the application.

16. The system of claim 15, wherein the test configuration comprises at least one of: (iii) a specification document comprising a function to be executable by the application, or (iv) a code history comprising a modification to a code for the application.

17. (canceled)

18. The system of claim 14, wherein, when generating the test package the one or more processors are further configured to generate a test script having computer-executable instructions comprising, for at least one test case of the plurality of test cases: (i) a condition for the application, (ii) the expected result from the application for the respective condition, (iii) a criterion against which to determine whether the at least one test case is satisfied, and (iv) a traceability mapping between the at least one test case and a risk control measure.

19.-20. (canceled)

21. The system of claim 14, the one or more processors are further configured to:
receive, via the user interface, a selection of one of approval or rejection of the test script, and
execute the computer-executable instructions based on the selection comprising approval of the test script.

22. The system of claim 14, the one or more processors are further configured to:
receive feedback data comprising a modification to a test script; and
update at least one of a plurality of weights of the generative model using the feedback data.

23. The system of claim 14, wherein, when receiving the test configuration, the one or more processors are further configured to:
receive, via the user interface, user input defining the plurality of test cases of the test configuration; and
provide, via the user interface, data associated with the test package.

24. (canceled)

25. The system of claim 14, wherein at least one of the plurality of corpuses includes a mapping between (i) a feature in at least one of (a) a respective scenario file, (b) a respective traceability table, (c) a specification document, or (d) a code history, with (ii) a feature in a respective test script,
wherein at least one of the plurality of test cases identifies a risk control measure for the application to be evaluated.

26. The system of claim 14, wherein the user is administered with a medication to address the indication, concurrently with provision of the application.
